(19) United States
(12) Patent Application Publication
(10) Pub. No.: US 2025/0078452 A1
(43) Pub. Date: Mar. 6, 2025

(54) IMAGE PROCESSING APPARATUS, IMAGE PROCESSING SYSTEM, AND IMAGE PROCESSING METHOD

(71) Applicant: PFU LIMITED, Kahoku-shi (JP)

(72) Inventor: Shota Yokogawa, Kahoku-shi (JP)

(21) Appl. No.: 18/806,459

(22) Filed: Aug. 15, 2024

(30) Foreign Application Priority Data
Aug. 28, 2023 (JP) 2023-137778

(51) Int. Cl. G06V 10/74

(52) U.S. Cl. CPC G06V 10/761

(57) ABSTRACT

An image processing apparatus includes a memory that stores a profile including a setting value of each of a plurality of setting items relating to imaging processing or image processing and circuitry. The circuitry acquires a plurality of input images obtained by imaging media. The circuitry identifies a plurality of pieces of characteristic information respectively relating to the plurality of setting items in each of the plurality of input images. The circuitry calculates, for each of the setting items, a degree of matching of each of the plurality of pieces of characteristic information with respect to the setting value in the plurality of input images. The circuitry outputs information regarding one or more setting items having the degree of matching equal to or higher than a predetermined value or a predetermined number of setting items in descending order of the degree of matching, among the plurality of setting items.

### CROSS-REFERENCE TO RELATED APPLICATION

This patent application is based on and claims priority pursuant to 35 U.S.C. § 119(a) to Japanese Patent Application No. 2023-137778, filed on Aug. 28, 2023, in the Japan Patent Office, the entire disclosure of which is hereby incorporated by reference herein.

### BACKGROUND

The present disclosure relates to an image processing apparatus, an image processing system, and an image processing method.

Currently, image processing apparatuses such as a scanner, which scans a plurality of media to generate images while sequentially conveying the media, have been used for imaging of various types of media in a wide variety of applications. The image quality required of such an image processing apparatus differs depending on, for example, the type of media to be read. In general, in the image processing apparatus, settings of various items regarding to imaging processing or image processing, such as a size or color, can be configured to generate an appropriate image according to, for example, the application or type of media. However, if the settings are wrong, the image processing apparatus may fail to acquire an appropriate image.

An image processing apparatus that executes a predetermined job in response to a start request operation by a user is known. The image processing apparatus compares a current apparatus initial value of regarding a setting value that is stored before execution of a predetermined job and relates to execution of the job with a previous apparatus initial value regarding a setting value relating to execution of a job when the predetermined job is last executed. When the current apparatus initial value is different from the previous apparatus initial value, the image processing apparatus displays a setting confirmation window indicating the current apparatus initial value before the job is executed.

An image processing apparatus that executes a job relating to image processing according to a plurality of job conditions assigned to one icon selected by a user from a plurality of displayed icons is known. The image processing apparatus stores, for each of a plurality of setting values of each of the plurality of job conditions, the number of times of execution of a job executed in the past by using the corresponding setting value, and calculates the degree of variation of the plurality of setting values in each of the job conditions by using the number of times of execution of the job with each of the setting values. The image processing apparatus determines one or more job conditions in ascending order of the degree of variation as representative job conditions for each function program. The image processing apparatus displays a list display window in which a plurality of icons are arranged, each icon including a type image representing a type of a job defined by the function program and a setting value image representing a setting value of a representative job condition of the function program.

### SUMMARY

In one aspect, an image processing apparatus includes a memory that stores a profile including a setting value of each of a plurality of setting items relating to imaging processing or image processing and circuitry. The circuitry acquires a plurality of input images obtained by imaging media. The circuitry identifies a plurality of pieces of characteristic information respectively relating to the plurality of setting items in each of the plurality of input images. The circuitry calculates, for each of the setting items, a degree of matching of each of the plurality of pieces of characteristic information with respect to the setting value in the plurality of input images. The circuitry outputs information regarding one or more setting items having the degree of matching equal to or higher than a predetermined value or a predetermined number of setting items in descending order of the degree of matching, among the plurality of setting items.

In another aspect, an image processing system includes an image reading apparatus including first circuitry and an information processing apparatus including second circuitry. The first circuitry and the second circuitry operate in cooperation to store a profile including a setting value of each of a plurality of setting items relating to imaging processing or image processing in a memory. The first circuitry and the second circuitry operate in cooperation to acquire a plurality of input images obtained by imaging media. The first circuitry and the second circuitry operate in cooperation to identify a plurality of pieces of characteristic information respectively relating to the plurality of setting items in the input image. The first circuitry and the second circuitry operate in cooperation to calculate, for each of the setting items, a degree of matching of each of the plurality of pieces of characteristic information with respect to the setting value in the plurality of input images. The first circuitry and the second circuitry operate in cooperation to output information regarding one or more setting items having the degree of matching equal to or higher than a predetermined value or a predetermined number of setting items in descending order of the degree of matching, among the plurality of setting items.

In another aspect, an image processing method includes storing a profile including a setting value of each of a plurality of setting items relating to imaging processing or image processing in a memory. The image processing method includes acquiring a plurality of input images obtained by imaging media. The image processing method includes identifying a plurality of pieces of characteristic information respectively relating to the plurality of setting items in the input image. The image processing method includes calculating, for each of the setting items, a degree of matching of each of the plurality of pieces of characteristic information with respect to the setting value in the plurality of input images. The image processing method includes outputting information regarding one or more setting items having the degree of matching equal to or higher than a predetermined value or a predetermined number of setting items in descending order of the degree of matching, among the plurality of setting items.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image processing system according to an embodiment;

FIG. 2 is a perspective view of an image reading apparatus of the image processing system illustrated in FIG. 1;

FIG. 3 is a diagram illustrating a conveyance passage inside the image reading apparatus illustrated in FIG. 2;

FIG. 4 is a schematic block diagram illustrating a configuration of the image reading apparatus illustrated in FIG. 2;

FIG. 5 is a schematic diagram for describing a data structure of a profile table according to an embodiment;

FIG. 6 is a schematic diagram for describing a data structure of a history table according to an embodiment;

FIG. 7 is a schematic diagram for describing characteristic information;

FIG. 8 is a schematic block diagram illustrating a configuration of a first storage device and a first processing circuit of the image reading apparatus illustrated in FIG. 4;

FIG. 9 is a schematic block diagram illustrating a configuration of the information processing apparatus of the image processing system illustrated in FIG. 1;

FIG. 10 is a flowchart illustrating an example of setting operation according to an embodiment;

FIG. 11 is a schematic diagram illustrating an example of a setting list window represented by display data according to an embodiment;

FIG. 12 is a schematic diagram for describing an important item;

FIG. 13 is a schematic diagram illustrating an example of a setting window represented by display data according to an embodiment;

FIG. 14 is a flowchart illustrating an example of image reading operation according to an embodiment;

FIG. 15 is a schematic diagram illustrating an example of a reading window represented by display data according to an embodiment;

FIG. 16 is a schematic block diagram illustrating a configuration of a first processing circuit according to another embodiment;

FIG. 17 is a schematic block diagram illustrating a configuration of a second storage device and a second processing circuit according to another embodiment; and

FIG. 18 is a schematic block diagram illustrating a configuration of a second processing circuit according to another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image processing apparatus, an image processing system, an image processing method, and a control program according to an aspect of the present disclosure are described below with reference to the drawings. However, the technical scope of the present disclosure is not limited to the embodiments described below but includes the scope of the appended claims and the equivalents thereof.

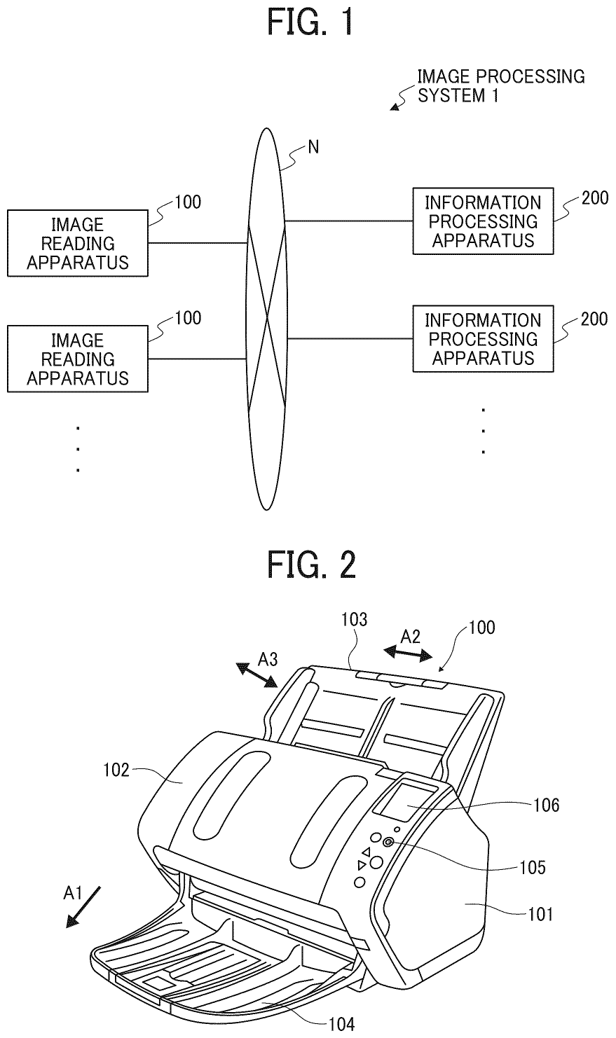

FIG. 1 is a schematic diagram illustrating a configuration of an image processing system 1 according to an embodiment.

As illustrated in FIG. 1, the image processing system 1 includes one or more image reading apparatuses 100 and one or more information processing apparatuses 200. The image reading apparatus 100 and the information processing apparatus 200 are communicably connected to each other through a network N. Examples of the network N include the Internet and an intranet. The image reading apparatus 100 and the information processing apparatus 200 are examples of an image processing apparatus.

For example, the image reading apparatus 100 is an automatic document feeder (ADF) type scanner device that images a medium such as a document while conveying the medium. Examples of the medium include a sheet of plain paper, a sheet of thin paper, a sheet of thick paper, and a card. Examples of the medium further include various types of media such as a receipt, a business card, an invoice, and a delivery note. The image reading apparatus 100 may be a facsimile machine, a copier, a multifunction peripheral (MFP), etc.

The image reading apparatus 100 may be a flatbed type apparatus that images a medium without conveying the medium.

Examples of the information processing apparatus 200 include a personal computer, a laptop personal computer, a tablet computer, and a smartphone. The information processing apparatus 200 may be a server provided in a cloud network.

FIG. 2 is a perspective view of the image reading apparatus 100 according to an embodiment.

The image reading apparatus100 includes a lower housing 101, an upper housing 102, a media tray 103, an ejection tray 104, a first input device 105, and a first display device 106.

The upper housing 102 is located at a position covering the upper face of the image reading apparatus 100, and is engaged with the lower housing 101 with a hinge such that the upper housing 102 can be opened and closed to, for example, remove a jammed medium or clean the inside of the image reading apparatus 100.

The media tray 103 is engaged with the lower housing 101 such that the media to be conveyed can be placed on the media tray 103. The ejection tray 104 is engaged with the lower housing 101 such that the media ejected from an ejection port can be placed on the ejection tray 104.

The first input device 105 includes an input device such as keys and an interface circuit that acquires signals from the input device. The first input device 105 receives an input operation performed by a user and outputs an operation signal corresponding to the input operation performed by the user. The first display device 106 includes a display and an interface circuit that outputs image data to the display and displays an image on the display according to the image data. Examples of the display include a liquid crystal display and an organic electro-luminescence (EL) display.

In FIG. 2, Arrow A1 indicates the direction in which media are conveyed (may be referred to as a “media conveyance direction A1” in the following description). Arrow A2 indicates the width direction of the image reading apparatus 100 (may be referred to as a “width direction A2” in the following description) perpendicular to the media conveyance direction A1. Arrow A3 indicates the height direction perpendicular to the media conveyance direction A1 and the width direction A2. In the following description, the term “upstream” refers to upstream in the media conveyance direction A1, and the term “downstream” refers to downstream in the media conveyance direction A1.

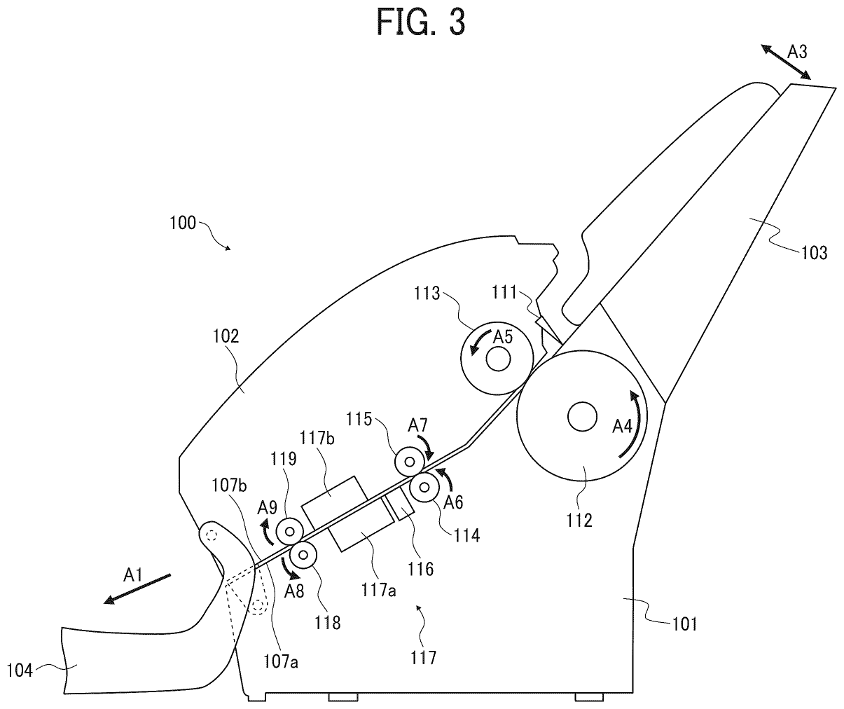

FIG. 3 is a diagram illustrating a conveyance passage inside the image reading apparatus 100 according to an embodiment.

The image reading apparatus 100 includes, along a conveyance passage, includes a first media sensor 111, a feed roller 112, a separation roller 113, a first conveyance roller 114, a second conveyance roller 115, a second media sensor 116, an imaging device 117, a third conveyance roller 118, and a fourth conveyance roller 119. The number of each of the above rollers is not limited to one, and may be two or more. When one or more of the above rollers are formed of multiple rollers, the multiple rollers are arranged at intervals in the width direction A2. The feed roller 112, the separation roller 113, the first conveyance roller 114, the second conveyance roller 115, the third conveyance roller 118, and the fourth conveyance roller 119 are collectively an example of a conveying device, and sequentially convey media.

The image reading apparatus 100 includes a so-called straight path. The upper face of the lower housing 101 forms a lower guide 107a for the media conveyance passage. The lower face of the upper housing 102 forms an upper guide 107b for the media conveyance passage.

The first media sensor 111 is located upstream from the feed roller 112 and the separation roller 113. The first media sensor 111 includes a contact detection sensor and detects whether a medium is placed on the media tray 103. The first media sensor 111 generates a first media signal of which the signal value changes depending on whether a medium is placed on the media tray 103 and outputs the generated first media signal. The first media sensor 111 is not limited to a contact detection sensor. The first media sensor 111 may be any other sensor that can detect the presence of a medium. Examples of any other sensor include an optical detection sensor.

The feed roller 112 is located in the lower housing 101 and feeds the media on the media tray 103 from the bottom. The separation roller 113 is a so-called brake roller or retard roller. The separation roller is located in the upper housing 102 and faces the feed roller 112. The feed roller 112 and the separation roller 113 function as separators that separate the media. A separation pad may be used instead of the separation roller 113.

The first conveyance roller 114 and the second conveyance roller 115 are located downstream from the feed roller 112 and the separation roller 113 and face each other. The first conveyance roller 114 and the second conveyance roller 115 convey the media fed by the feed roller 112 and the separation roller 113 to the imaging device 117.

The second media sensor 116 is located downstream from the first conveyance roller 114 and the second conveyance roller 115 and upstream from the imaging device 117, and detects a medium conveyed to the position where the second media sensor 116 is located. The second media sensor 116 includes a light emitter, a light receiver, and a light guide. The light emitter and the light receiver are located on one side of the media conveyance passage (e.g., the lower housing 101 side). The light guide is located at a position facing the light emitter and the light receiver with the media conveyance passage therebetween (e.g., the upper housing 102 side). The light emitter is, for example, a light-emitting diode (LED), and emits light toward the media conveyance passage. The light receiver is, for example, a photodiode and receives light emitted from the light emitter and guided by the light guide. When the medium is present at a position facing the second media sensor 116, the light emitted from the light emitter is blocked by the medium, and therefore the light receiver does not detect the light emitted from the light emitter. Based on the intensity of the light received, the light receiver generates and outputs a second media signal of which the signal value changes between when a medium is present at the position of the second media sensor 116 and when a medium is absent at the position of the second media sensor 116. The number of the second media sensor 116 may be two or more. When the number of the second media sensor 116 is two or more, the second media sensors 116 are arranged at intervals in the width direction A2.

A reflector such as a mirror may be used instead of the light guide. The light emitter and the light receiver are located facing each other with the media conveyance passage therebetween. Further, the second media sensor 116 may detect the presence of the medium with, for example, a contact sensor that allows a certain current to flow when a medium is in contact with the contact sensor or when no medium is in contact with the contact sensor.

The imaging device 117 is an example of an imaging unit. The imaging device 117 is located downstream from the first conveyance roller 114 and the second conveyance roller 115 and upstream from the third conveyance roller 118 and the fourth conveyance roller 119. The imaging device 117 includes a first imaging device 117a and a second imaging device 117b. The first imaging device 117a and the second imaging device 117b are located near the media conveyance passage and face each other with the media conveyance passage therebetween.

The first imaging device 117a includes a light source and a line sensor based on a unity-magnification optical system type contact image sensor (CIS) including complementary metal oxide semiconductor- (CMOS-) based imaging elements linearly arranged in a main scanning direction. The first imaging device 117a further includes lenses each forming an image on an imaging element, and an analog-to-digital (A/D) converter amplifying and A/D converting an electric signal output from the imaging element. The first imaging device 117a generates an input image by imaging the front side of each of the media sequentially conveyed by the conveying device and outputs the input image.

In substantially the same manner, the second imaging device 117b includes a light source and a line sensor based on a unity-magnification optical system type CIS including CMOS-based imaging elements linearly arranged in a main scanning direction. The second imaging device 117b further includes lenses each forming an image on an imaging element, and an analog-to-digital (A/D) converter amplifying and A/D converting an electric signal output from the imaging element. The second imaging device 117b generates an input image by imaging the back side of each of the media sequentially conveyed by the conveying device and outputs the input image.

The image reading apparatus 100 may include either the first imaging device 117a or the second imaging device 117b to read only one side of the medium. Instead of the line sensor based on a unity-magnification optical system type CIS including CMOS-based imaging elements, a line sensor based on a unity-magnification optical system type CIS including charge-coupled device- (CCD-) based imaging elements may be used. Alternatively, a line sensor employing a reduction optical system and including a CMOS or CCD imaging element may be used.

The third conveyance roller 118 and the fourth conveyance roller 119 are located downstream from the imaging device 117 and face each other. The third conveyance roller 118 and the fourth conveyance roller 119 eject the media conveyed by the first conveyance roller 114 and the second conveyance roller 115 onto the ejection tray 104.

As the feed roller 112 rotates in the direction of Arrow A4 in FIG. 3, the medium on the media tray 103 is conveyed between the lower guide 107a and the upper guide 107b in the media conveyance direction A1. The separation roller 113 rotates or stops in the direction of Arrow A5 in FIG. 3 when conveying the media. Due to the action of the feed roller 112 and separation roller 113, when a plurality of media is placed on the media tray 103, only the medium in contact with the feed roller 112 among the media placed on the media tray 103 is separated. This prevents the feeding of a medium other than the separated medium. In other words, the multiple feeding is prevented.

The medium is fed between the first conveyance roller 114 and the second conveyance roller 115 while being guided by the lower guide 107a and the upper guide 107b. As the first conveyance roller 114 rotates in the direction of Arrow A6 in FIG. 3 and the second conveyance roller 115 rotates in the direction of Arrow A7 in FIG. 3, the medium is fed between the first imaging device 117a and the second imaging device 117b. As the third conveyance roller 118 rotates in the direction of Arrow A8 in FIG. 3 and the fourth conveyance roller 119 rotates in the direction of Arrow A9 in FIG. 3, the medium read by the imaging device 117 is ejected to the ejection tray 104.

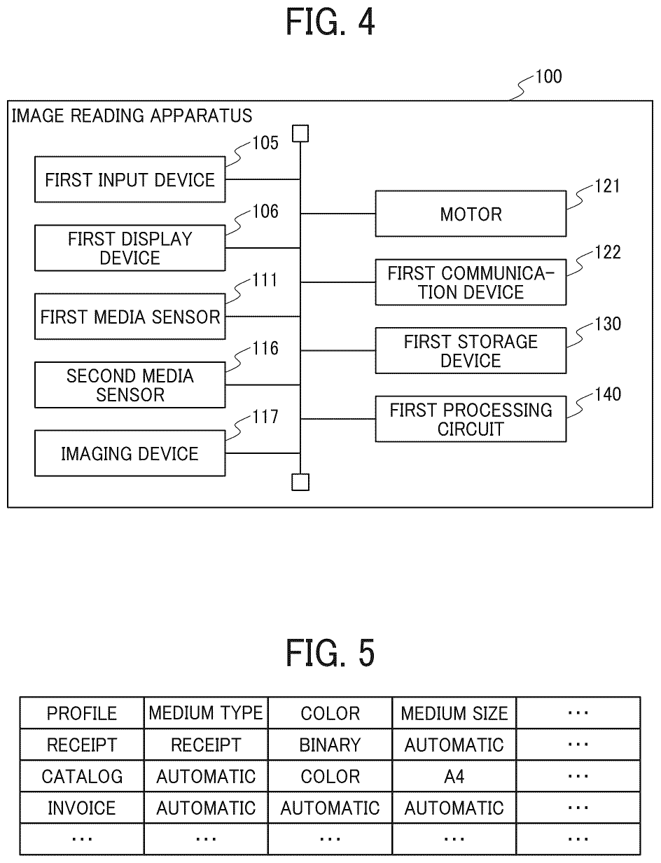

FIG. 4 is a schematic block diagram illustrating a configuration of the image reading apparatus 100 according to an embodiment.

In addition to the configuration described above, the image reading apparatus 100 includes a motor 121, a first communication device 122, a first storage device 130, and a first processing circuit 140.

The motor 121 includes one or a plurality of motors. The motor 121 rotates the feed roller 112, the separation roller 113, the first conveyance roller 114, the second conveyance roller 115, the third conveyance roller 118, and the fourth conveyance roller 119 according to a control signal from the first processing circuit 140 to perform the conveyance operation of the media. One of the first conveyance roller 114 and the second conveyance roller 115 may be a driven roller rotated by the rotation of the other roller. One of the third conveyance roller 118 and the fourth conveyance roller 119 may be a driven roller rotated by the rotation of the other roller.

The first communication device 122 includes an antenna and a wireless communication interface circuit. The antenna transmits and receives radio signals. The wireless communication interface circuit transmits and receives signals through a wireless communication line according to a communication protocol such as a wireless local area network (LAN) protocol. The first communication device 122 communicates with the information processing apparatus 200. The first communication device 122 transmits and receives various images and information to and from the information processing apparatus 200 according to an instruction from the first processing circuit 140. The first communication device 122 may include a wired communication interface circuit according to a communication protocol such as the Transmission Control Protocol/Internet Protocol (TCP/IP), and may be connected to the information processing apparatus 200 through a network. The first communication device 122 may have an interface circuit compatible with a serial bus such as the Universal Serial Bus (USB) and may be connected to the information processing apparatus 200 via a wired cable such as a USB cable.

The first storage device 130 is an example of a memory. The first storage device 130 includes memories such as a random-access memory (RAM) and a read-only memory (ROM), a fixed disk device such as a hard disk, or a portable memory such as a flexible disk or an optical disc. The first storage device 130 stores computer programs, databases, tables, etc. used for various processes performed by the image reading apparatus 100. The computer programs may be installed in the first storage device 130 from a computer-readable portable recording medium using, for example, a known setup program.

Examples of the portable recording medium include a compact disc-read-only memory (CD-ROM) and a digital versatile disc-read-only memory (DVD-ROM).

The computer programs may be distributed from a server and installed in the first storage device 130.

Further, the first storage device 130 stores, for example, a profile table, a history table as data. Information regarding a profile is stored in the profile table.

The profile is settings regarding imaging processing or image processing that can be specified by a user according to, for example, the usage of the input image or the type of a medium to be imaged. The profile includes setting values respectively for multiple setting items regarding imaging processing or image processing. A detailed description is given later of the profile table. The history table stores histories regarding input images for each of input images generated by the image reading apparatus 100. A detailed description is given later of the history table.

The first processing circuit 140 operates according to a program pre-stored in the first storage device 130. The first processing circuit 140 is, for example, a central processing unit (CPU). Alternatively, a digital signal processor (DSP), a large scale integration (LSI), an application-specific integrated circuit (ASIC), a field-programmable gate array (FPGA), etc. may be used as the first processing circuit 140.

The first processing circuit 140 is connected to the first input device 105, the first display device 106, the first media sensor 111, the second media sensor 116, the imaging device 117, the motor 121, the first communication device 122, the first storage device 130, etc., and controls each of these components. The first processing circuit 140 sets a profile specified by a user via the first input device 105 or the first communication device 122 in the first storage device 130. The first processing circuit 140 controls, for example, the driving of the motor 121 and the imaging by the imaging device 117 according to the profile that is specified by the user and acquires an input image. Further, the first processing circuit 140 calculates, for multiple input images, the degree of matching of the characteristic of each of the multiple input image with respect to the setting value of each of setting items included in the profile. The first processing circuit 140 outputs information regarding a setting item of which the degree of matching is equal to or greater than a predetermined value or a predetermined number of setting items in descending order of the degree of matching to the first communication device 122 or the first display device 106.

FIG. 5 is a schematic diagram for describing a data structure of the profile table according to an embodiment.

As illustrated in FIG. 5, the profile table stores a setting value of each of multiple setting items in association with other for each of one or more profiles. The profile includes a receipt, a catalog, an invoice, etc.

The setting items are items regarding imaging processing or image processing. The setting items are items specifying content of an operation by the image reading apparatus 100 for imaging a medium or image processing to be executed on an input image obtained by imaging the medium. The setting items include a medium type, a color, a medium size, resolution, dropout color, carrier sheet recognition, barcode recognition, optical character recognition (OCR), an OCR language setting, blank page removal, orientation correction, continuous scanning, edge correction, punch hole removal, and tab cropping. The color, medium size, resolution, etc. are settings relating to the imaging processing. The medium type, color, medium size, resolution, dropout color, carrier sheet recognition, barcode recognition, zone OCR, OCR language setting, blank page removal, orientation correction, continuous scanning, edge correction, punch hole removal, tab cropping, etc. are settings relating to image processing.

The medium type is a setting of the type of a medium to be imaged. Examples of the setting value of the medium type include receipt, catalog, invoice, and automatic. When the automatic is set, the image reading apparatus 100 detects the size and/or color of a conveyed medium based on the detection result of the medium by the second media sensor 116 and/or the input image generated by the imaging device 117. The image reading apparatus 100 stores the correspondence relationship between the medium type and the size and/or color of a medium in the first storage device 130 in advance, and detects the medium type associated with the detected size and/or color of the medium as the medium type of the medium. The image reading apparatus 100 may detect the medium type by a discriminator that is pre-trained to output the type of a medium included in an image when the image is input. For example, the discriminator is pre-trained by deep learning with multiple images including various types of media and pre-stored in the first storage device 130. The image reading apparatus 100 inputs the input image to the discriminator and detects the medium type based on information output from the discriminator. In image processing, the image reading apparatus 100 stores the input image in a storage location that is preset for each of the set or detected medium types, and/or applies an application (processing) that is preset for each of the set or detected medium types to the input image.

The color is the setting of the color of the input image. Examples of the setting value of the color include binary, gray scale, color, and automatic.

When the automatic is set, the image reading apparatus 100 automatically detects the color (binary, gray scale, or color) of the medium included in the input image based on the input image generated by the imaging device 117 and generates an image according to the detected color. The image reading apparatus 100 can change the color of the input image to be generated by setting, for example, the color of light emitted by the light source of the imaging device 117, the gradation range to be converted by the A/D converter in imaging processing. Further, the image reading apparatus 100 can change the color of an image in image processing by performing, for example, gray scale conversion or binarization of the color input image generated in the imaging processing.

The medium size is the setting of the size of the medium included in the input image. Examples of the setting value of the medium size include A4 size, A5 size, A6 size, B4 size, B5 size, B6 size, post card size, business card size, others, and automatic. When the automatic is set, the image reading apparatus 100 automatically detects the size of a conveyed medium based on the detection result of the medium by the second media sensor 116 or the input image generated by the imaging device 117. The image reading apparatus 100 can generate the input image including a medium of the medium size being set or detected by setting, for example, the timing at which the imaging device 117 finishes the imaging and the position of the imaging element in the line sensor to be used for imaging in the imaging processing. Further, the image reading apparatus 100 can generate an image including a medium of the medium size being set by performing, in the image processing, cropping of the input image generated in the imaging processing.

The resolution is a setting of the resolution of the input image. Examples of the setting value of the resolution include 150 dots per inch (dpi), 200 dpi, 300 dpi, 600 dpi, and 1200 dpi. The image reading apparatus 100 can generate the input image of which resolution is the resolution being set, by setting, for example, the media conveyance speed, the imaging timing (time interval) by the imaging device 117, and the position of the imaging element in the line sensor to be used for imaging in the imaging processing. Further, the image reading apparatus 100 can generate an image of which resolution is the resolution being set by performing, in the image processing, thinning or interpolation of the input image generated in the imaging processing.

The dropout color is a setting for removing a specific color component included in the input image using a known image processing technique. Examples of the setting value of the dropout color include ON and OFF. When ON is set, a color component to be removed is additionally set. The dropout color is used to generate an image in which an object having a specific color component such as a stamp is removed from the input image of a medium with the object.

The carrier sheet recognition is a setting for detecting colorless and transparent carrier sheets with a conveyed medium interposed therebetween from the input image. Examples of the setting value of the carrier sheet recognition include ON and OFF. When the setting value of the carrier sheet recognition is set to ON, the image reading apparatus 100 determines whether the input image contains a specific symbol that the carrier sheet includes. When the input image contains the specific symbol, the image reading apparatus 100 combines an input image obtained by imaging the front side and an input image obtained by imaging the back side.

The barcode recognition is a setting for detecting a barcode from the input image. Examples of the setting value of the barcode recognition include ON and OFF. The OCR is a setting for performing character recognition on an input image. Examples of the setting value of the OCR include ON and OFF. When ON is set, an area on which character recognition is to be performed is additionally set. The OCR language setting is a setting for designating the language of characters to be recognized by OCR. The blank page removal is a setting for deleting an input image when the medium included in the input image is a blank sheet. Examples of the setting value of the blank page removal include ON and OFF. The orientation correction is a setting for correcting the orientation of a medium included in the input image using a known image processing technique such as rotation processing. Examples of the setting value of the orientation correction include 0°, 90° (clockwise) rotation, 90° (counterclockwise) rotation, 180° rotation, and automatic. The continuous scanning is a setting for continuously reading a medium newly placed by a user after the reading of all the media placed on the media tray 103 is completed. Examples of the setting value of the continuous scanning include ON and OFF.

The edge correction is a setting for detecting the outer shape (edge) of a medium in the input image using a known image processing technique, determining that the medium is folded or torn when one or more corners of the medium are not right angles or the one or more sides of the medium are not straight lines, and correcting the outer shape of the medium to a rectangular shape. Examples of the setting value of the edge correction include ON and OFF. The punch hole removal is a setting for determining whether a punch hole is included in the input image using a known image processing technique and removing the punch hole when the punch hole is included. Examples of the setting value of the punch hole removal include ON and OFF. The tab cropping is a setting for determining whether a tab such as a piece of paper or the like attached to protrude from a medium is included in the input image using a known image processing technique and removing the tab when the tab is included. Examples of the setting value of the tab cropping include ON and OFF.

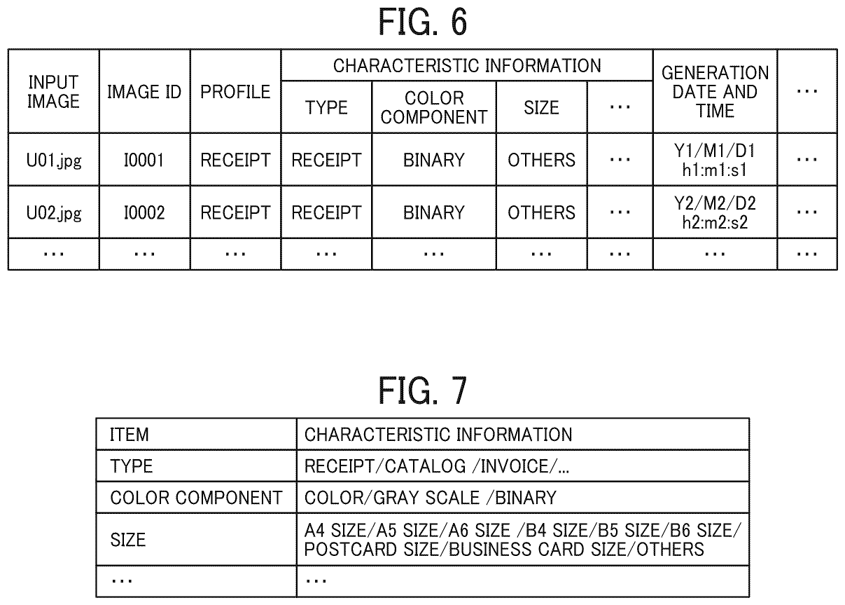

FIG. 6 is a schematic diagram for describing a data structure of the history table according to an embodiment.

As illustrated in FIG. 6, the history table stores an image identifier (ID), a profile, characteristic information, a generation date and time, etc. in association with each other for each of input images generated by the image reading apparatus 100. The image ID is information for identifying the input image. The profile is the profile that was set when the associated input image was generated. The characteristic information is the characteristic information identified based on the associated input image. The generation date and time is the date and time when the associated input image was generated.

FIG. 7 is a schematic diagram for describing the characteristic information.

As illustrated in FIG. 7, characteristic information pieces are identified from input images. Each of the characteristic information pieces indicates a characteristic of an input image regarding the imaging processing or the image processing, in particular, a characteristic of a medium included in the input image. The characteristic information pieces relate to the setting items regarding the imaging processing or the image processing defined by the profile. Items defined by the characteristic information include the type, color component, size, medium resolution, number of dropout pixels, presence of carrier sheet, presence of barcode, presence of character, language, presence of blank sheet, orientation, presence of continuous scanning, presence of edge to be corrected, presence of punch hole, and presence of tab.

The type indicates the type of a medium included in the input image and relates to the medium type among the setting items defined by the profile. The color component indicates a component such as color, gray scale, or binary included in the input image and relates to the color among the setting items defined by the profile. The size indicates the size of a medium included in the input image and relates to the media size among the setting items defined by the profile.

The medium resolution indicates the resolution (print resolution) of an object included in a medium included in the input image and relates to the resolution among the setting items defined by the profile. The number of dropout pixels indicates the number of pixels having a particular color component included in the input image and relates to the dropout color among the setting items defined by the profile. The presence of carrier sheet indicates whether a carrier sheet is included in the input image and relates to the carrier sheet recognition among the setting items defined by the profile.

The presence of barcode indicates whether a barcode is included in the input image and relates to the barcode recognition among the setting items defined by the profile. The presence of character indicates whether a character is included in the input image. When a character is included in the input image, the presence of character indicates the position of the character in the input image. The presence of character relates to the OCR among the setting items defined by the profile. The language indicates a language of a character included in the input image and relates to the OCR language setting among the setting items defined by the profile. The presence of blank sheet indicates whether a blank sheet is included in the input image and relates to the blank page removal among the setting items defined by the profile. The orientation indicates the orientation of a medium included in the input image and relates to the orientation correction among the setting items defined by the profile. The presence of continuous scanning indicates whether the continuous scanning was performed and relates to the continuous scanning among the setting items defined by the profile.

The presence of edge correction indicates whether a fold or a tear is present in a medium included in the input image and relates to the edge correction among the setting items defined by the profile. The presence punch hole indicates whether a punch hole is included in the input image and relates to the punch hole removal among the setting items defined by the profile. The presence of tab indicates whether a tab is included in the input image and relates to the tab cropping among the setting items defined by the profile.

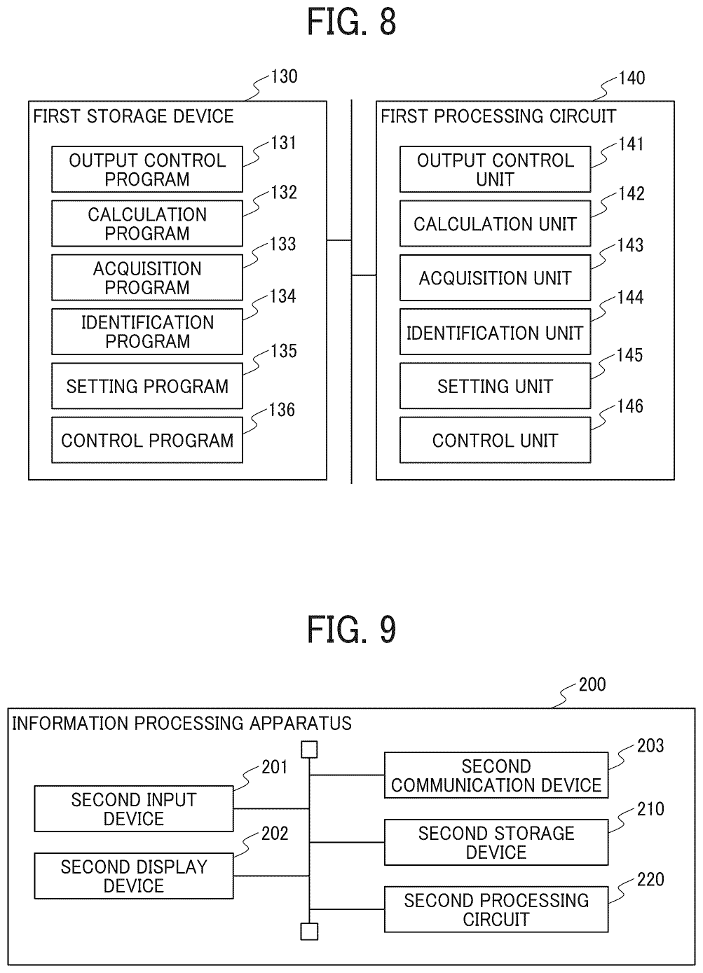

FIG. 8 is a schematic block diagram illustrating a configuration of the first storage device 130 and the first processing circuit 140 according to an embodiment.

As illustrated in FIG. 8, the first storage device 130 stores an output control program 131, a calculation program 132, an acquisition program 133, an identification program 134, a setting program 135, and a control program 136. These programs are functional modules implemented by software operating on a processor. The first processing circuit 140 reads the programs stored in the first storage device 130 and operates according to the read programs, thereby functioning as an output control unit 141, a calculation unit 142, an acquisition unit 143, an identification unit 144, a setting unit 145, and a control unit 146.

FIG. 9 is a schematic block diagram illustrating a configuration of the information processing apparatus 200 according to an embodiment.

The information processing apparatus 200 includes a second input device 201, a second display device 202, a second communication device 203, a second storage device 210, and a second processing circuit 220.

The second input device 201 includes an input device such as a keyboard and a mouse, and an interface circuit that acquires signals from the input device. The second input device 201 outputs a signal corresponding to an operation by a user to the second processing circuit 220.

The second display device 202 includes a display such as a liquid crystal display and an organic EL display, and an interface circuit that outputs image data to the display. The second display device 202 displays various types of information on the display according to an instruction from the second processing circuit 220.

The second communication device 203 includes an antenna that transmits and receives radio signals, and a wireless communication interface circuit that transmits and receives signals through a wireless communication line according to a predetermined communication protocol such as a wireless LAN protocol. The second communication device 203 can communicate with the image reading apparatus 100. The second communication device 203 transmits and receives various images and information to and from the image reading apparatus 100 according to an instruction from the second processing circuit 220. The second communication device 203 may include a wired communication interface circuit according to a communication protocol such as the TCP/IP, and may be connected to the image reading apparatus 100 through a network. The first communication device 122 may include an interface circuit compatible with a serial bus such as a USB and may be connected to the image reading apparatus 100 through a wired cable such as a USB cable.

The second storage device 210 is an example of a memory. The second storage device 210 includes a memory as a RAM and a ROM, a fixed disk device such as a hard disk, or a portable memory such as a flexible disk or an optical disc. The second storage device 210 stores computer programs, databases, tables, etc. used for various processes performed by the information processing apparatus 200. The computer programs may be installed in the second storage device 210 from a computer-readable portable recording medium such as a CD-ROM or a DVD-ROM using, for example, a known setup program. Further, the computer programs may be distributed from, for example, a server and installed in the second storage device 210.

The second processing circuit 220 operates according to a program prestored in the second storage device 210. The second processing circuit 220 is, for example, a CPU. As the second processing circuit 220, a DSP, a LSI, an ASIC, a FPGA, etc. may be used.

The second processing circuit 220 is connected to the second input device 201, the second display device 202, the second communication device 203, the second storage device 210, etc. and controls each of these devices. The second processing circuit 220 performs, for example, control of transmitting and receiving data to and from the image reading apparatus 100 via the second communication device 203, input control of the second input device 201, and display control of the second display device 202.

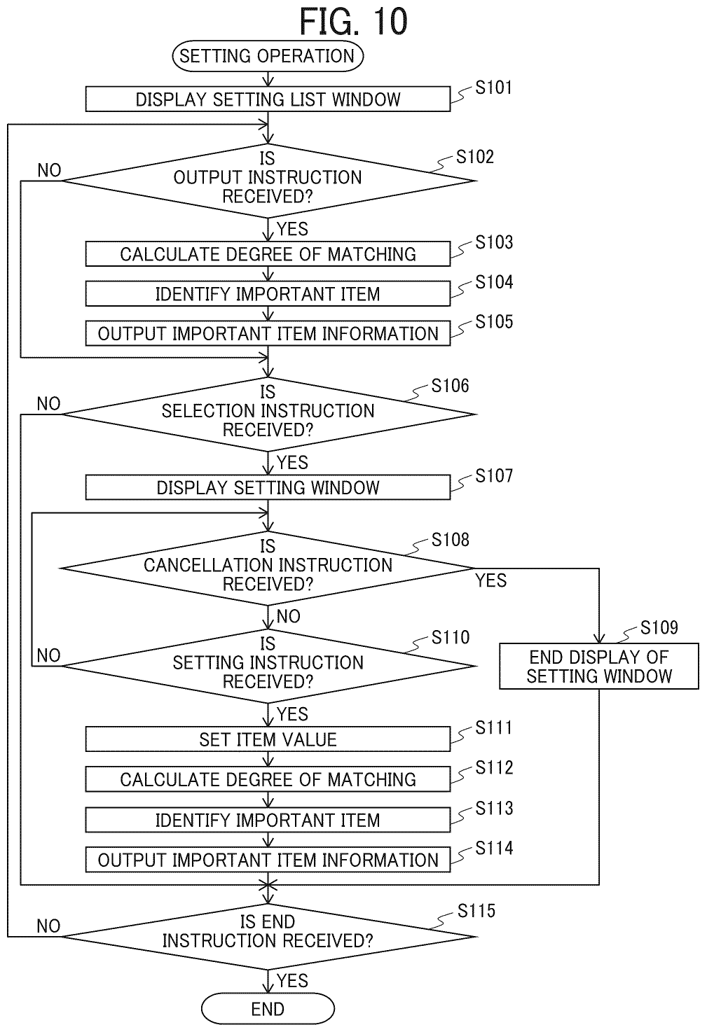

FIG. 10 is a flowchart illustrating an example of setting operation according to an embodiment.

A description is now given of setting operation performed by the image reading apparatus 100 with reference to FIG. 10 according to an embodiment. The flow of the operation described below is executed by the first processing circuit 140 in cooperation with the components of the image reading apparatus 100 according to the program prestored in the first storage device 130. The operation of the flowchart illustrated in FIG. 10 is executed before the execution of image reading operation described later or during the execution of the image reading operation (i.e., in parallel with the image reading processing).

First, the output control unit 141 generates display data of a setting list window and outputs the generated display data by displaying the display data on the first display device 106 or transmitting the display data to the information processing apparatus 200 via the first communication device 122 (step S101). When the information processing apparatus 200 receives the display data from the image reading apparatus 100 via the second communication device 203, the information processing apparatus 200 displays the received display data on the second display device 202.

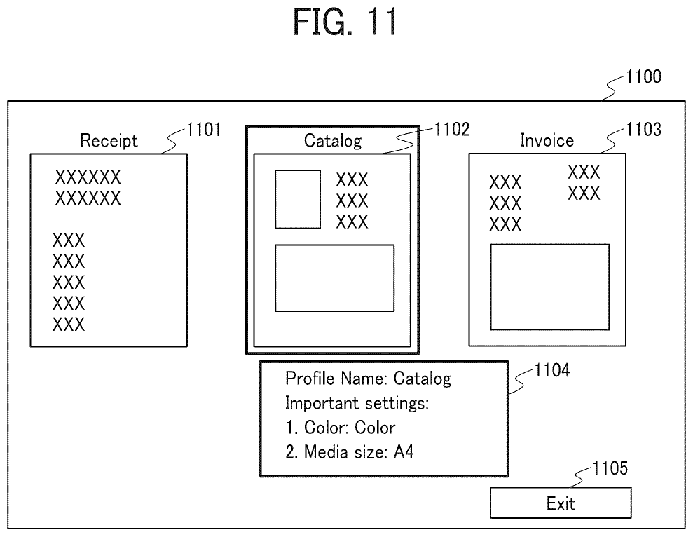

FIG. 11 is a schematic diagram illustrating an example of the setting list window represented by the display data according to an embodiment.

As illustrated in FIG. 11, a setting list window 1100 represented by the display data includes multiple icons 1101 to 1103, important item information 1104, and an exit button 1105. Although FIG. 11 illustrates setting list window 1100 including the important item information 1104, the important item information 1104 is not displayed when the setting list window 1100 is displayed for the first time. The icons 1101 to 1103 respectively correspond multiple profiles. The icons 1101 to 1103 enables to configure settings relating to the corresponding profiles respectively. The important item information 1104 indicates one or more important setting items and the setting values of the important items among multiple setting items defined by each of the profiles corresponding to the icons 1101 to 1103. In the following description, the important setting item among multiple setting items defined by each of the profiles may be referred to as an “important item.” The exit button 1105 is a button for ending the display of the setting list window 1100.

Subsequently, the output control unit 141 determines whether an output instruction instructing the output of an important item of a particular profile is received (step S102). In response to a user's operation of designating a certain icon in a predetermined manner using the first input device 105 or the information processing apparatus 200 on the setting list window 1100, the output control unit 141 receives the output instruction of the important item of the profile corresponding to the designated icon. By receiving an output instruction signal designating the particular profile from the first input device 105 or the first communication device 122, The output control unit 141 receives the output instruction of the important item of the particular profile. When the output control unit 141 does not receive the output instruction of the important item, the output control unit 141 does not perform any process, and the operation proceeds to step S106.

By contrast, when the output control unit 141 receives the output instruction of the important item, the calculation unit 142 calculates, for each of the setting items included in the designated profile, the degree of matching indicating how the corresponding characteristic information in multiple input images match the setting value of each of the setting items (step S103). The multiple input images are input images acquired by the acquisition unit 143 up to the present time in image reading operation described later. The characteristic information in each of the input images is identified by the identification unit 144 when each of the input images is acquired in the image reading operation described later.

For example, the multiple input images are all the input images generated up to the present time. The multiple input images may be input images generated in a predetermined time period. For example, the predetermined time period is the most recent predetermined time period (e.g., the most recent one month or the most recent one week). The predetermined time period may be a predetermined time period (e.g., the first half or the second half). In other words, in this case, the calculation unit 142 calculates the degree of matching using input images generated in the predetermined time period. Accordingly, the image reading apparatus 100 can appropriately calculate the degree of matching even when the format of the medium is changed at a certain time point or when the format of the medium is changed at time period intervals.

Regarding the medium type, the color, and the medium size, when a setting value is other than automatic, the calculation unit 142 determines that the characteristic information matches setting values when the type, the color component, and the size identified as the characteristic information match the setting values. In this case, the calculation unit 142 determines that the characteristic information does not match the setting values when the type, the color component, and the size identified as the characteristic information do not match the setting values. The calculation unit 142 calculates the ratio of the number of input images for which the characteristic information is determined to match the setting values to the total number of input images to be subjected to the determination as the degree of matching. By contrast, when the setting value is automatic, the image reading apparatus 100 has to automatically detect the medium type, color, or medium size. This increases the processing load and processing time of the image reading operation. Accordingly, if all the media to be imaged are of the same type, it is not preferable to automatically detect the medium type, color, or medium size. Therefore, when the setting value is automatic, the calculation unit 142 sets the degree of matching to the highest value when the number of types of the identified characteristic information is plural, and sets the degree of matching to the lowest value when the number of types of the identified characteristic information is only one.

Regarding the resolution, the calculation unit 142 determines that the characteristic information matches the setting value when a medium resolution identified as the characteristic information matches the setting value, and determines that the characteristic information does not match the setting value when the medium resolution identified as the characteristic information does not match the setting value. The calculation unit 142 calculates the ratio of the number of input images for which the characteristic information is determined to match the setting value to the total number of input images to be subjected to the determination as the degree of matching.

Regarding the dropout color, when the setting value is ON, the calculation unit 142 determines that the characteristic information matches the setting value when the number of pixels having a particular color component included in the input image identified as the characteristic information is within a predetermined range. In this case, the calculation unit 142 determines that the characteristic information does not match the setting value when the number of pixels having a particular color component included in the input image identified as the characteristic information is outside the predetermined range. By contrast, when the setting value is OFF, the calculation unit 142 determines that the characteristic information matches the setting value when the number of pixels having a particular color component included in the input image identified as the characteristic information is outside a predetermined range. In this case, the calculation unit 142 determines that the characteristic information does not match the setting value when the number of pixels having a particular color component included in the input image identified as the characteristic information is within the predetermined range. The calculation unit 142 calculates the ratio of the number of input images for which the characteristic information is determined to match the setting value to the total number of input images to be subjected to the determination as the degree of matching.

Regarding the carrier sheet recognition, the barcode recognition, the blank page removal, the edge correction, the punch hole removal, and the tab cropping, when the setting value is ON, the calculation unit 142 determines that the characteristic information matches the setting value when it is identified as the characteristic information that each object (i.e., a carrier sheet, a barcode, a blank sheet, a medium having a fold or a tear, a punch hole, or a tab) is included in the input image. In this case, the calculation unit 142 determines that the characteristic information does not match the setting value when it is identified as the characteristic information that each object is not included in the input image. By contrast, when the setting value is OFF, the calculation unit 142 determines that the characteristic information matches the setting value when it is identified as the characteristic information that each object is not included in the input image. In this case, the calculation unit 142 determines that the characteristic information does not match the setting value when it is identified as the characteristic information that each object is included in the input image. The calculation unit 142 calculates the ratio of the number of input images for which the characteristic information is determined to match the setting value to the total number of input images to be subjected to the determination as the degree of matching.

Regarding the OCR, when the setting value is ON, the calculation unit 142 determines that the characteristic information matches the setting value when it is identified as the characteristic information that the input image contains a predetermined number or more of characters and the positions of the characters are within an area designated by the setting value. In this case, the calculation unit 142 determines that the characteristic information does not match the setting value when it is identified as the characteristic information that the input image does not contain the predetermined number or more of characters or the positions of the characters are outside the area designated by the setting value. By contrast, when the setting value is OFF, the calculation unit 142 determines that the characteristic information matches the setting value when it is identified as the characteristic information that the input image does not contain the predetermined number or more of characters. In this case, the calculation unit 142 determines that the characteristic information does not match the setting value when it is identified as the characteristic information that the input image contains the predetermined number or more of characters. The calculation unit 142 calculates the ratio of the number of input images for which the characteristic information is determined to match the setting value to the total number of input images to be subjected to the determination as the degree of matching.

Regarding the OCR language setting, the calculation unit 142 determines that the characteristic information matches the setting value when a language identified as the characteristic information matches the setting value, and determines that the characteristic information does not match the setting value when the language identified as the characteristic information does not match the setting value. The calculation unit 142 calculates the ratio of the number of input images for which the characteristic information is determined to match the setting value to the total number of input images to be subjected to the determination as the degree of matching.

Regarding the orientation correction, when the setting value is other than automatic, the calculation unit 142 determines that the characteristic information matches the setting value when the medium orientation identified as the characteristic information is correct (upward) when the input image is rotated in the direction set by the setting value. In this case, the calculation unit 142 determines that the characteristic information does not match the setting value when the medium orientation identified as the characteristic information is not correct in a state where the input image is rotated in the direction set by the setting value. The calculation unit 142 calculates the ratio of the number of input images for which the characteristic information is determined to match the setting values to the total number of input images to be subjected to the determination as the degree of matching. By contrast, when the setting value is automatic, the calculation unit 142 sets the degree of matching to the highest value when any of the medium orientations identified as the characteristic information is different, and sets the degree of matching to the lowest value when all of the medium orientations are the same.

Regarding the continuous scanning, when the setting value is ON, the calculation unit 142 determines that the characteristic information matches the setting value when it is identified that continuous scanning has been performed as the characteristic information. In this case, the calculation unit 142 determines that the characteristic information does not match the setting value when it is identified that continuous scanning has not been performed as the characteristic information. By contrast, when the setting value is OFF, the calculation unit 142 determines that the characteristic information matches the setting value when it is identified that continuous scanning has not been performed as the characteristic information. In this case, the calculation unit 142 determines that the characteristic information does not match the setting value when it is identified that continuous scanning has been performed as the characteristic information. The calculation unit 142 calculates the ratio of the number of groups including an input image for which the characteristic information is determined to match the setting value to the total number of groups of input images continuously generated as the degree of matching.

Regarding the carrier sheet recognition, the barcode recognition, the blank page removal, the edge correction, the punch hole removal, the tab cropping, the OCR, and/or the orientation correction, when the setting value is ON, the calculation unit 142 may calculate the ratio of the number of groups including an input image for which the characteristic information is determined to match the setting value to the total number of groups of input images continuously generated as the matching degree of matching. Further, when the setting value is OFF, the calculation unit 142 may calculate the ratio of the number of groups that do not include an input image for which the characteristic information is determined to match the setting value to the total number of groups of input images continuously generated as the degree of matching.

Subsequently, the output control unit 141 identifies an important item among the multiple setting items included in the designated profile (step S104). For example, the output control unit 141 identifies a setting item of which the degree of matching is equal to or greater than a predetermined value as an important item among the multiple setting items included in the designated profile. The predetermined value is preset to any desired value. Different values may be set as the predetermined values respectively for the setting items. The output control unit 141 may identify a predetermined number of setting items as important items in descending order of the degree of matching among the multiple setting items included in the designated profile. The predetermined number is preset to any desired value of 1 or greater than 2.

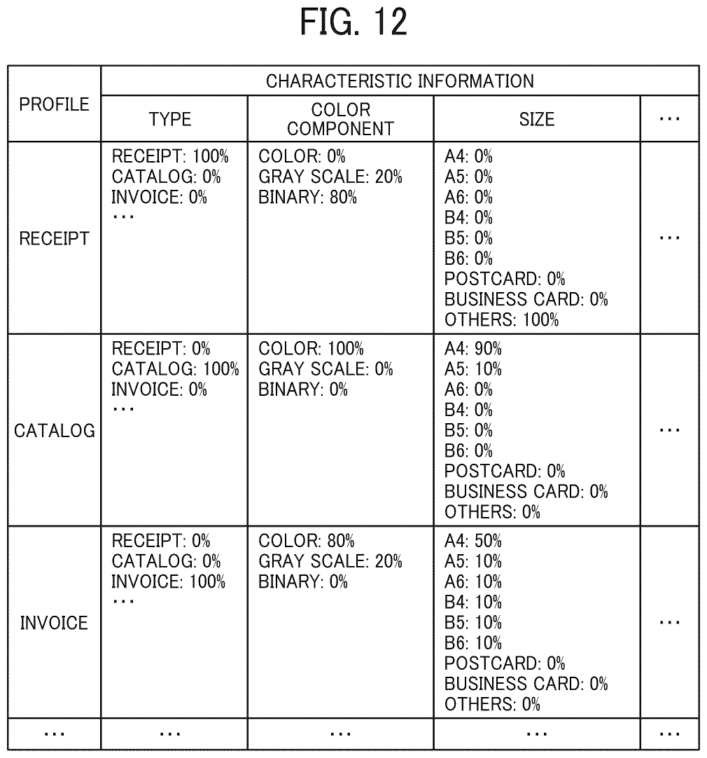

FIG. 12 is a schematic diagram for describing the important item.

FIG. 12 is a table illustrating an example of the ratio of each of characteristic information pieces identified from an input image generated with each of the setting values illustrated in FIG. 5 being set for each of profiles illustrated in FIG. 5.

Regarding the setting item “medium type” of the profile “receipt,” the setting value is “receipt,” and the ratio of “receipt” in the characteristic information is 100%. Accordingly, the degree of matching is 100%. Regarding the setting item “color” of the profile “receipt,” the setting value is “binary” and the ratio of “binary” in the characteristic information is 80%. Accordingly, the degree of matching is 80%. Regarding the setting item “medium size” of the profile “receipt,” the setting value is “automatic,” and the ratio of the characteristic information is larger than 0% only for “others.” Accordingly, the degree of matching is 0%. For example, when the predetermined value is set to 90%, the setting item “medium type” is identified as the important item for the profile “receipt.” Alternatively, when the predetermined number is set to 2, the setting items “medium type” and “color” are identified as the important items for the profile “receipt.”

Regarding the setting item “medium type” of the profile “catalog,” the setting value is “automatic,” and the ratio of the characteristic information is larger than 0% only for “catalog.” Accordingly, the degree of matching is 0%. Regarding the setting item “color” of the profile “catalog,” the setting value is “color” and the ratio of “color” in the characteristic information is 100%. Accordingly, the degree of matching is 100%. Regarding the setting item “medium size” of the profile “catalog,” the setting value is “A4” and the ratio of “A4” in the characteristic information is 90%. Accordingly, the degree of matching is 90%. For example, when the predetermined value is set to 90%, the setting items “medium type” and “medium size” are identified as the important items for the profile “catalog.” Alternatively, when the predetermined number is set to 2, the setting items “medium type” and “medium size” are identified as the important items for the profile “catalog.”

Regarding the setting item “medium type” of the profile “invoice,” the setting value is “automatic,” and the ratio of the characteristic information is larger than 0% only for “invoice.” Accordingly, the degree of matching is 0%. Regarding the setting item “color” of the profile “invoice,” the setting value is “automatic,” and the ratio of the characteristic information is larger than 0% for two characteristic information pieces “color” and “gray scale.” Accordingly, the degree of matching is 100%. Regarding the setting item “medium size” of the profile “invoice,” the setting value is “automatic,” and the ratio of the characteristic information is larger than 0% for six characteristic information pieces “A4,” “A5,” “A6,” “B4,” “B5,” and “B6.” Accordingly, the degree of matching is 100%. For example, when the predetermined value is set to 90%, the setting items “medium size” and “color” are identified as the important items for the profile “invoice.” Alternatively, when the predetermined number is set to 2, the setting items “medium size” and “color” are identified as the important items for the profile “invoice.”

Characteristic information identified from the input image indicates the characteristic of an imaged medium. Accordingly, the setting item having a higher degree of matching with the characteristic feature is likely to be an item distinctly representing the characteristic feature of the medium. The image reading apparatus 100 can notify a user of information relating to a setting item distinctly representing the characteristic of a medium by identifying a setting item having a high degree of matching as the important item.

Subsequently, the output control unit 141 outputs important item information indicating the identified important item and the setting value of the identified important item by displaying the important item information on the first display device 106 or transmitting the important item information to the information processing apparatus 200 via the first communication device 122 (step S105). The important item information is an example of information relating to an important item. When the information processing apparatus 200 receives the important item information from the image reading apparatus 100 via the second communication device 203, the information processing apparatus 200 displays the received important item information on the second display device 202.

Thus, as illustrated in FIG. 11, the important item information 1104 relating to the important items identified for the profile “catalog” designated by the user is displayed on the setting list window 1100.

As described above, the output control unit 141 outputs important item information when receiving designation of a profile by a user. This allows the user to check a setting item that clearly represents the characteristic of the designated profile and/or the setting value of the setting item. Accordingly, the user can easily and appropriately select a profile to be set when a medium as an imaging target is imaged. Thus, the image reading apparatus 100 can enhance user convenience.

As described above, the setting operation is performed before or during the image reading operation described later. In other words, the output control unit 141 outputs the important item information before or during the reading of a medium by the image reading apparatus 100. This allow the user to check a setting item that clearly represents the characteristic of a profile and/or the setting value of the setting item before or during the reading of a medium and to change the profile at an early stage when the profile is not suitable for imaging a medium as an imaging target. Accordingly, the image reading apparatus 100 can prevent re-scanning from being performed in medium reading processing, thus reducing the working time of a user.

Subsequently, the output control unit 141 determines whether an instruction to select a profile is received (step S106). In response to a user's operation of selecting a certain icon in a predetermined manner using the first input device 105 or the information processing apparatus 200 on the setting list window 1100, the output control unit 141 receives the instruction of the profile corresponding to the selected icon. By receiving a selection instruction signal designating the particular profile from the first input device 105 or the first communication device 122, the output control unit 141 receives the selection instruction of the profile. When the output control unit 141 does not receive the selection instruction of the profile, the output control unit 141 does not perform any process, and the operation proceeds to step S115.

By contrast, when the output control unit 141 receives the selection instruction of the profile, the output control unit 141 generates display data of a setting window. The output control unit 141 outputs the generated display data by displaying the display data on the first display device 106 or transmitting the display data to the information processing apparatus 200 via the first communication device 122 (step S107). When the information processing apparatus 200 receives the display data from the image reading apparatus 100 via the second communication device 203, the information processing apparatus 200 displays the received display data on the second display device 202.

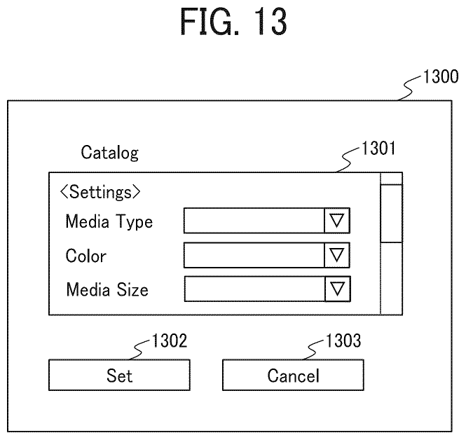

FIG. 13 is a schematic diagram illustrating an example of the setting window represented by the display data according to an embodiment.

As illustrated in FIG. 13, a setting window 1300 represented by the display data includes a setting object 1301, a setting button 1302, and a cancel button 1303. The setting object 1301 includes a selection box for designating a setting value for each of multiple setting items of the selected profile. The user can designate the setting value of each of the setting item for the selected profile by using the setting object 1301. The setting button 1302 is a button for setting each of the setting values designated by using the setting object 1301. The cancel button 1303 is a button for ending the display of the setting window 1300.

Subsequently, the output control unit 141 determines whether a cancellation instruction is received (step S108). In response to a user's operation of pressing the cancel button 1303 using the first input device 105 or the information processing apparatus 200 on the setting window 1300, the output control unit 141 receives the cancellation instruction. By receiving a cancellation instruction signal from the first input device 105 or the first communication device 122, the output control unit 141 receives the cancellation instruction.

When the output control unit 141 receives the cancellation instruction, the output control unit 141 ends the display of the setting window 1300 (step S109), and the operation proceeds to step S115. Thus, the setting list window 1100 is displayed again. When the setting window 1300 is displayed on the information processing apparatus 200, the output control unit 141 transmits a request signal requesting to end the display of the setting window 1300 to the information processing apparatus 200 via the first communication device 122. When the information processing apparatus 200 receives the request signal from the image reading apparatus 100 via the second communication device 203, the information processing apparatus 200 ends the display of the setting window 1300.

By contrast, when the output control unit 141 does not receive the cancellation instruction, the output control unit 141 determines whether a setting instruction is received (step S110). In response to a user's operation of pressing the setting button 1302 using the first input device 105 or the information processing apparatus 200 on the setting window 1300, the output control unit 141 receives the setting instruction of the corresponding profile. By receiving a setting instruction signal designating the profile designated on the setting list window 1100 and the setting values designated by using the setting object 1301 from the first input device 105 or the first communication device 122, the output control unit 141 receives the setting instruction. When the output control unit 141 does not receive the setting instruction, the operation returns to step S108.

By contrast, when the output control unit 141 receives the setting instruction, the setting unit 145 sets the designated setting values for the designated profile (step S111). The setting unit 145 sets the designated setting values respectively for multiple setting items for the designated profile in the profile table. Thus, the setting unit 145 stores the profile designated by the user in the first storage device 130.

Subsequently, the calculation unit 142 calculates the degree of matching for each of the multiple setting items included in the designated profile, i.e., the profile in which the setting value has been changed (step S112). The calculation unit 142 calculates the degree of matching in the same or substantially the same manner as described referring to step S103. Specifically, when a setting value included in the profile is changed, the calculation unit 142 calculates, as the degree of matching, how the characteristic information matches a setting value of the profile including the changed setting value in multiple input images generated according to a profile including a setting value before the change. Thus, the calculation unit 142 can appropriately calculate the degree of matching of each of the setting items after the change by using the input images generated up to the present time.

Subsequently, the output control unit 141 identifies an important item among multiple setting items included in the designated profile, i.e., the profile in which the setting value has been changed (step S113). The output control unit 141 identifies an important item in the same or substantially the same manner as described referring to step S104.

Subsequently, the output control unit 141 outputs important item information indicating the identified important item and the setting value of the identified important item by displaying the important item information on the first display device 106 or transmitting the important item information to the information processing apparatus 200 via the first communication device 122 (step S114). The output control unit 141 ends the display of the setting window 1300 in the same or substantially the same manner as described referring to step S109. Thus, the setting list window 1100 is displayed again. Then, the output control unit 141 outputs the important item information indicating the identified important item and the setting value of the important item in the same or substantially the same manner as described referring to step S105. Thus, the important item information relating to the important item identified for the profile in which the setting value has been changed is displayed on the setting list window 1100.

Subsequently, the output control unit 141 determines whether an end instruction is received (step S115). In response to a user's operation of pressing the exit button 1105 using the first input device 105 or the information processing apparatus 200 on the setting list window 1100, the output control unit 141 receives the end instruction. By receiving an end instruction signal from the first input device 105 or the first communication device 122, the output control unit 141 receives the end instruction. When the output control unit 141 does not receive the end instruction, the output control unit 141 returns the operation to step S102 and repeats the processes of step S102 and subsequent steps. By contrast, when the output control unit 141 receives the end instruction, the output control unit 141 ends the display of the setting list window 1100 and ends the series of steps.

Alternatively, the output control unit 141 may identify important items of all the profiles before generating the display data of the setting list window 1100, and generate the display data of the setting list window 1100 so that the important items of all the profiles are displayed before the designation by the user. Still alternatively, the output control unit 141 may generate the display data of the setting list window 1100 so that when a cursor that moves according to an operation to each input device is placed on a certain profile, the important item of the certain profile is displayed.

Still alternatively, the output control unit 141 may generate the display data of the setting list window 1100 so that an icon corresponding to each of the profiles is displayed in a mode corresponding to the important item of each profile and the setting value of the important item on the setting list window 1100. For example, when the important item is a medium type, the output control unit 141 sets an icon representing the medium type (e.g., receipt, catalog, invoice) as the icon of the profile. Further, for example, when the important item is color, the output control unit 141 sets an icon expressed in the setting value (e.g., color, gray scale, binary) of the color as the icon of the profile. The user can visually imagine the characteristic of each profile by the appearance of the icon, and the image reading apparatus 100 can further enhance user convenience.

Further, either or both of the processes of steps S102 to S105 and the processes of steps S106 to S114 may be omitted.

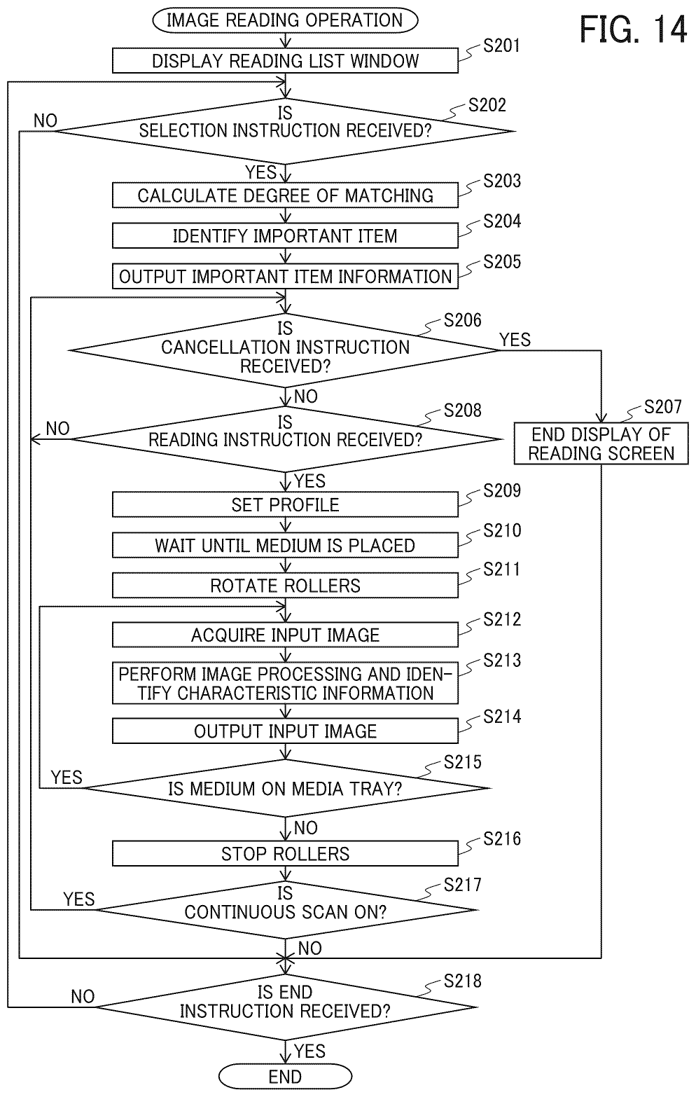

FIG. 14 is a flowchart illustrating an example of image reading operation according to an embodiment.

A description is now given of image reading operation performed by the image reading apparatus 100 with reference to FIG. 14 according to an embodiment. The flow of the operation described below is executed by the first processing circuit 140 in cooperation with the components of the image reading apparatus 100 according to the program prestored in the first storage device 130.

First, the output control unit 141 generates display data of a reading list window and outputs the generated display data by displaying the display data on the first display device 106 or transmitting the display data to the information processing apparatus 200 via the first communication device 122 (step S201). When the information processing apparatus 200 receives the display data from the image reading apparatus 100 via the second communication device 203, the information processing apparatus 200 displays the received display data on the second display device 202. The reading list window is the same window as the setting list window illustrated in FIG. 11.

Subsequently, the output control unit 141 determines whether an instruction to select a profile is received (step S202). In response to a user's operation of selecting a certain icon in a predetermined manner using the first input device 105 or the information processing apparatus 200 on the reading list window, the output control unit 141 receives the instruction of the profile corresponding to the selected icon. By receiving a selection instruction signal designating the particular profile from the first input device 105 or the first communication device 122, the output control unit 141 receives the selection instruction of the profile. When the output control unit 141 does not receive the selection instruction of the profile, the output control unit 141 does not perform any process, and the operation proceeds to step S218.

By contrast, when the output control unit 141 receives the selection instruction of the profile, the calculation unit 142 calculates the degree of matching for each of the multiple setting items included in the designated profile, i.e., the profile used for reading a medium (step S203). The calculation unit 142 calculates the degree of matching in the same or substantially the same manner as described referring to step S103 of FIG. 10.

Subsequently, the output control unit 141 identifies an important item among the multiple setting items included in the designated profile, i.e., the profile used for reading a medium (step S204). The output control unit 141 identifies an important item in the same or substantially the same manner as described referring to step S104 of FIG. 10.

Subsequently, the output control unit 141 outputs important item information indicating the identified important item and the setting value of the identified important item by displaying the important item information on the first display device 106 or transmitting the important item information to the information processing apparatus 200 via the first communication device 122 (step S205). The output control unit 141 generates display data of a reading window including the important item information indicating the identified important item and the setting value of the identified important item. The output control unit 141 outputs the generated display data by displaying the display data on the first display device 106 or transmitting the display data to the information processing apparatus 200 via the first communication device 122. When the information processing apparatus200 receives the display data from the image reading apparatus 100 via the second communication device 203, the information processing apparatus 200 displays the received display data on the second display device 202.

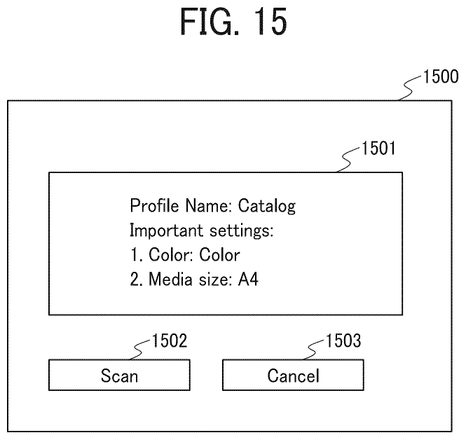

FIG. 15 is a schematic diagram illustrating an example of the reading window represented by the display data according to an embodiment.

As illustrated in FIG. 15, a reading window 1500 represented by the display data includes important item information 1501, a scan button 1502, and a cancel button 1503. The important item information 1501 indicates important setting items and setting values of the important setting items among multiple setting items defined by the profile designated in step S202. The scan button 1502 is a button for executing the reading of a medium according to the designated profile. The cancel button 1303 is a button for ending the display of the reading window 1500.

As described above, the output control unit 141 outputs important item information when receiving designation of a profile by a user. This allows the user to check a setting item that clearly represents the characteristic of the designated profile and/or the setting value of the setting item. Accordingly, the user can easily and appropriately select a profile to be set when a medium as an imaging target is imaged. Thus, the image reading apparatus 100 can enhance user convenience.

Further, the output control unit 141 outputs the important item information before the image reading apparatus 100 reads a medium. This allow the user to check a setting item that clearly represents the characteristic of a profile and/or the setting value of the setting item before the reading of a medium and to change the profile appropriately when the profile is not suitable for imaging a medium as an imaging target. Accordingly, the image reading apparatus 100 can prevent re-scanning from being performed in medium reading processing, thus reducing the working time of a user.

Further, the output control unit 141 continues to display the reading window during the reading of a medium by the image reading apparatus 100. In other words, the output control unit 141 outputs the important item information before the reading of a medium by the image reading apparatus 100. This allow the user to check a setting item that clearly represents the characteristic of a profile and/or the setting value of the setting item during the reading of a medium and to change the profile appropriately when the profile is not suitable for imaging a medium as an imaging target. Accordingly, the image reading apparatus 100 can prevent the increase of the number of media for which re-scanning is to be performed in medium reading processing, thus reducing the working time of a user.

Subsequently, the output control unit 141 determines whether a cancellation instruction is received (step S206). In response to a user's operation of pressing the cancel button 1503 using the first input device 105 or the information processing apparatus 200 on the reading window 1500, the output control unit 141 receives the cancellation instruction. By receiving a cancellation instruction signal from the first input device 105 or the first communication device 122, the output control unit 141 receives the cancellation instruction.

When the output control unit 141 receives the cancellation instruction, the output control unit 141 ends the display of the reading window 1500 (step S207), and the operation proceeds to step S218. Thus, the reading list window is displayed again. When the reading window 1500 is displayed on the information processing apparatus 200, the output control unit 141 transmits a request signal requesting to end the display of the reading window 1500 to the information processing apparatus 200 via the first communication device 122. When the information processing apparatus 200 receives the request signal from the image reading apparatus 100 via the second communication device 203, the information processing apparatus 200 ends the display of the reading window 1500.

By contrast, when the output control unit 141 does not receive the cancellation instruction, the output control unit 141 determines whether a reading instruction is received (step S208). In response to a user's operation of pressing the setting button 1302 using the first input device 105 or the information processing apparatus 200 on the reading window 1500, the output control unit 141 receives the reading instruction according to the corresponding profile. By receiving a reading instruction signal designating the profile designated on the reading list window from the first input device 105 or the first communication device 122, the output control unit 141 receives the reading instruction. When the output control unit 141 does not receive the reading instruction, the operation returns to step S206.

Subsequently, the setting unit 145 acquires the profile included in the reading instruction signal, and stores (sets) the acquired profile in the first storage device 130. The setting unit 145 configures the settings of, for example, the imaging device 117 and the motor 121 to generate an input image according to the acquired profile (step S209). The setting unit 145 configures the settings of, for example, the imaging device 117 and the motor 121 to generate the input image having a quality equal to or higher than the quality of an image according to the profile being set. For example, the setting unit 145 configure settings of, for example, the imaging device 117 and the motor 121 to generate the input image of which the resolution is the maximum resolution supported by the image reading apparatus 100, the medium size is the maximum medium size supported by the image reading apparatus 100, and the color is color. Thus, the image reading apparatus 100 can appropriately determine whether the profile being set matches the characteristic of the input image based on the input image.

The profile may be designated by the user before inputting the instruction to read a medium and stored in the first storage device 130, instead of being designated along with the instruction to read the medium. In such a case, the setting unit 145 acquires the profile by reading the profile from the first storage device 130.

Subsequently, the control unit 146 waits until a medium is placed on the media tray 103 (step S210). The control unit 146 acquires a first media signal from the first media sensor 111 and determines whether a medium is placed on the media tray 103 based on the acquired first media signal.

Subsequently, the control unit 146 drives the motor 121 to rotate the feed roller 112, the separation roller 113, the first conveyance roller 114, the second conveyance roller 115, the third conveyance roller 118, and/or the fourth conveyance roller 119 (step S211). Thus, the control unit 146 feeds and conveys a medium from the media tray 103. The control unit 146 controls the motor 121 so that an input image according to the profile acquired in step S209 is generated. The control unit 146 controls the motor 121 in particular to rotate at a speed that implements generation of an image with the resolution specified by the profile.

Subsequently, the acquisition unit 143 acquires the input image obtained by imaging the conveyed medium from the imaging device 117, and stores the input image in the first storage device 130 (step S212).

For example, the acquisition unit 143 determines whether the leading end of the medium has passed the position of the second media sensor 116 based on the second media signal received from the second media sensor 116. The acquisition unit 143 acquires the second media signals periodically from the second media sensor 116 and determines that the leading end of the medium has passed the position of the second media sensor 116 when the signal value of the second media signal changes from a value indicating the absence of a medium to a value indicating the presence of a medium. The acquisition unit 143 controls the imaging device 117 to start imaging when the leading end of the medium has passed the position of the second media sensor 116. The control unit 146 controls the imaging device 117 to generate an input image according to the profile acquired in step S209.

Thereafter, the acquisition unit 143 controls the imaging device 117 to finish imaging when the medium has been conveyed by the amount obtained by adding a margin to the medium size indicated by the profile being set in step S209. The acquisition unit 143 may control the imaging device 117 to finish imaging when the trailing end of the medium has passed through the imaging position of the imaging device 117. For example, the acquisition unit 143 determines whether the trailing end of the medium has passed the position of the second media sensor 116 based on the second media signal received from the second media sensor 116. The acquisition unit 143 acquires the second media signals periodically from the second media sensor 116 and determines that the trailing end of the medium has passed the position of the second media sensor 116 when the signal value of the second media signal changes from a value indicating the presence of a medium to a value indicating the absence of a medium. The acquisition unit 143 determines that the trailing end of the medium has passed the imaging position of the imaging device 117 when a predetermined time period has elapsed after the trailing end of the medium passes the position of the second media sensor 116. The predetermined time period is set to a time taken for a medium to move from the second media sensor 116 to the imaging position.

The acquisition unit 143 acquires an input image from the imaging device 117 every time the imaging device 117 generates a predetermined lines of the input image and synthesizes the acquired input images when the imaging device 117 finishes imaging. The control unit 146 may collectively acquire input images for all lines at a time when the imaging device 117 finishes the imaging.

The acquisition unit 143 acquires multiple input images by acquiring an input image from the imaging device 117 every time a medium is conveyed.

Subsequently, the identification unit 144 performs image processing on the acquired input images and identifies multiple pieces of characteristic information in each of the input images (step S213). The control unit 146 performs image processing on the input image according to the profile being set in step S209. The identification unit 144 assigns a new image ID to the acquired input image, and stores the acquired input image, the assigned image ID, the acquired profile, the identified pieces of characteristic information, and the current time in the history table in association with each other.

For example, regarding the type, the identification unit 144 identifies the type of a medium included in the input image by a discriminator that is pre-trained to output the type of a medium included in an image when the image is input. For example, the discriminator is pre-trained by deep learning with multiple images including various types of media and pre-stored in the first storage device 130. The identification unit 144 inputs the input image to the discriminator and identifies the type of a medium included in the input image based on the information output from the discriminator.

The identification unit 144 may perform OCR processing and identify the type of a medium included in the input image based on the recognized characters. In this case, the image reading apparatus 100 pre-stores a table storing keywords that respectively corresponds to the types in the first storage device 130. For example, the table stores a keyword “receipt” in association with the type “receipt,” a keyword “product” in association with the type “catalog,” and a keyword “invoice” in association with the type “invoice.” The identification unit 144 refers to the table and identifies a particular type corresponding to the recognized character. The identification unit 144 may identify the type of a medium included in the input image based on a characteristic other than characters such as a rule ruled line, a stamp imprint, and an arrangement position of a characters.

Regarding the color component, the identification unit 144 determines whether the color component included in the input image is color or black and white based on the distribution of the color values such as the R value, G value, or B value of each pixel in the input image for which image processing has not performed yet. The identification unit 144 calculates the variances of the color values of the pixels in the input image. When the average value of the calculated variances is equal to or greater than a predetermined color variance threshold value, the identification unit 144 determines that the component of the color included in the input image is color. When the average value of the calculated variances is smaller than the predetermined color variance threshold value, the identification unit 144 determines that the component of the color included in the input image is black and white. When the identification unit 144 determines that the component of the color is black and white, the identification unit 144 determines whether the component of the color included in the input image is gray scale or binary based on the distribution of the luminance values of the pixels in the input image. The identification unit 144 calculates the variances of the luminance values of the pixels in the input image. When the calculated variances are equal to or greater than a predetermined luminance variance threshold value, the identification unit 144 determines that the component of the color included in the input image is gray scale. When the calculated variances are smaller than the predetermined luminance variance threshold value, the identification unit 144 determines that the component of the color included in the input image is binary.

Regarding the size, the identification unit 144 extracts edge pixels of which gradation values such as brightness values or color values differ from the gradation values of the adjacent pixels by equal to or greater than a predetermined gradation threshold value in the input image for which image processing has not been performed yet. The identification unit 144 detects the largest area among areas surrounded by the edge pixels adjacent to each other as a medium area. The identification unit 144 identifies the size of a medium included in the input image based on the number of pixels of the detected medium area and the resolution being set when the input image is generated.

Regarding the medium resolution, the identification unit 144 performs frequency conversion such as Fourier transform on the input image for which image processing has not performed yet and identifies the distribution of spatial frequencies in the input image. The image reading apparatus 100 pre-stores a table or an equation indicating the relation between the spatial frequency maximum value in the input image and the resolution (print resolution) of an object included in the medium included in the input image in the first storage device 130. The identification unit 144 refers to the table or the expression and identifies a resolution corresponding to the spatial frequency maximum value in the input image as the medium resolution. Regarding the number of dropout pixels, the identification unit 144 identifies the number of pixels having a specific color component, i.e., the number of pixels removed in the image processing, as the number of dropout pixels. Regarding the presence of carrier sheet, the identification unit 144 identifies whether the input image includes the specific symbol included in the carrier sheet using a known image processing technique.

Regarding the presence of barcode, the identification unit 144 determines whether a barcode is included in an image using a discriminator pre-trained to output whether a barcode is included in an image when the image is input. For example, the discriminator is pre-trained by deep learning with multiple images including various barcodes and pre-stored in the first storage device 130. The identification unit 144 inputs the input image to the discriminator and determines whether a barcode is included in the input image based on information output from the discriminator. Regarding the presence of character, the identification unit 144 performs OCR processing on the input image and determines whether a character is included in the input image based on whether a character is detected. Further, when a character is detected in the input image, the identification unit 144 identifies the position at which each character is detected in the input image as the position of each character in the input image. Regarding the language, the identification unit 144 performs OCR processing on the input image and identifies the language of a character detected in the input image.

Regarding the presence of blank sheet, the identification unit 144 detects a medium area in the input image in the same or substantially the same manner as identifying the size and determines whether a blank sheet is included in the input image based on whether the number of edge pixels included in the detected medium area is equal to or less than a predetermined threshold value. Regarding the orientation, the identification unit 144 performs OCR while rotating the input image by 90 degrees, for example, and determines that the orientation of a medium included in the input image in which the largest number of characters are detected is a correct orientation. The identification unit 144 identifies the orientation of the medium in the input image before the rotation based on the determination result. Regarding the presence of continuous scanning, the identification unit 144 identifies whether the continuous scanning is performed in operation described later. Regarding the presence of edge correction, the identification unit 144 identifies detects a medium area in the input image in the same or substantially the same manner as identifying a size. The identification unit 144 identifies whether a fold is present in the medium based on whether the angle of the medium area is within a predetermined range including 90°. The identification unit 144 identifies whether a tear is present in the medium based on whether the distance between a straight line corresponding to a side of the medium area and a pixel closest to the straight line is within a predetermined distance.

Regarding the presence of punch hole, the identification unit 144 detects areas surrounded by the edge pixels adjacent to each other and detects a medium area in the input image in the same or substantially the same manner as identifying a size. The identification unit 144 identifies whether a punch hole is included in the input image depending on whether there is an area that is located near the edges of the medium area and has a substantially circular shape among the areas surrounded by the edge pixels adjacent to each other. Regarding the presence of tab, the identification unit 144 detects areas surrounded by the edge pixels adjacent to each other in the same or substantially the same manner as identifying a size, and detects the largest rectangular area among the areas surrounded by the edge pixels adjacent to each other as a medium area. The identification unit 144 identifies whether a tab is included in the input image depending on whether there is an area that is located outside the medium area and adjacent to the medium area and has a substantially rectangular shape among the areas surrounded by the edge pixels adjacent to each other.

Subsequently, the acquisition unit 143 outputs the input image on which the image processing has been executed by transmitting the input image to the information processing apparatus 200 via the first communication device 122 (step S214). When the information processing apparatus 200 receives the input image from the image reading apparatus 100 via the second communication device 203, the information processing apparatus 200 displays the received input image on the second display device 202.

Subsequently, the control unit 146 determines whether a medium remains on the media tray 103 based on the first media signal received from the first media sensor 111 (step S215). When a medium remains on the media tray 103, the control unit 146 returns the operation to step S212 and repeats the processes of steps S212 to S215.

By contrast, when no media remains on the media tray 103, the control unit 146 stops the motor 121 to stop the feed roller 112, the separation roller 113, the first conveyance roller 114, the second conveyance roller 115, the third conveyance roller 118, and the fourth conveyance roller 119 (step S216). Thus, the control unit 146 stops conveying media.

Subsequently, the control unit 146 determines whether the continuous scanning is set to ON in the profile being set in step S209 (step S217). When the continuous scanning is set to ON, the control unit 146 returns the operation to step S206 and repeats the processes of step S206 and the subsequent steps. Thus, when a user places a new medium on the media tray 103 and presses the scan button 1502, the continuous reading is performed. When the continuous reading is performed, the identification unit 144 stores information indicating that the continuous reading is performed in the history table, regarding the presence of continuous scanning of the characteristic information associated with the corresponding input image. When the continuous reading is performed, the profile is not changed. In this case, the process of step S209 may be omitted.

By contrast, when the continuous scanning is set to OFF, the output control unit 141 determines whether an end instruction is received (step S218). In response to a user's operation of pressing an exit button using the first input device 105 or the information processing apparatus 200 on the reading list window, the output control unit 141 receives the end instruction. By receiving an end instruction signal from the first input device 105 or the first communication device 122, the output control unit 141 receives the end instruction. When the output control unit 141 does not receive the end instruction, the output control unit 141 returns the operation to step S202 and repeats the processes of step S202 and subsequent steps. By contrast, when the output control unit 141 receives the end instruction, the output control unit 141 ends the display of the reading list window and ends the series of steps.

Alternatively, the processes of steps S203 to S204 may be omitted, and the output control unit 141 may output display data of the reading window that does not include important item information in step S205.

As described above in detail, the image reading apparatus 100 notifies a user of a setting item whose setting value has a high degree of matching with the characteristic information of input images generated in the past among multiple setting items included in a profile as an important setting item. This allows the user to check a setting item that clearly represents the characteristic of each of the profiles and/or the setting value of the setting item. Accordingly, the user can easily and appropriately select a profile to be set when a medium as an imaging target is imaged. Thus, the image reading apparatus 100 can enhance user convenience.

Further, the image reading apparatus 100 can also prevent a user from selecting an inappropriate profile. Accordingly, the image reading apparatus 100 can prevent re-scanning from being performed in medium reading processing, thus reducing the working time of a user.

Currently, image processing apparatuses have been used for imaging of various types of media in a wide variety of applications. In image processing apparatuses, the number of setting items for reading media is increasing in order to support various applications and various types of media. Therefore, when a user is notified of information relating to all the setting items, the user has to check a large number of setting items. This may take a long time for the user to check the setting items. Since the image reading apparatus 100 notifies the user of only an important setting item, the user can focus on only the important setting item and determine whether the profile of the important setting item is appropriate. Accordingly, the image reading apparatus 100 can prevent the user from selecting an inappropriate profile and further reduce the user's efforts for checking.

Further, the image reading apparatus 100 can collectively set multiple setting items regarding imaging processing or image processing by using the profile. This enhances the work efficiency of the user.

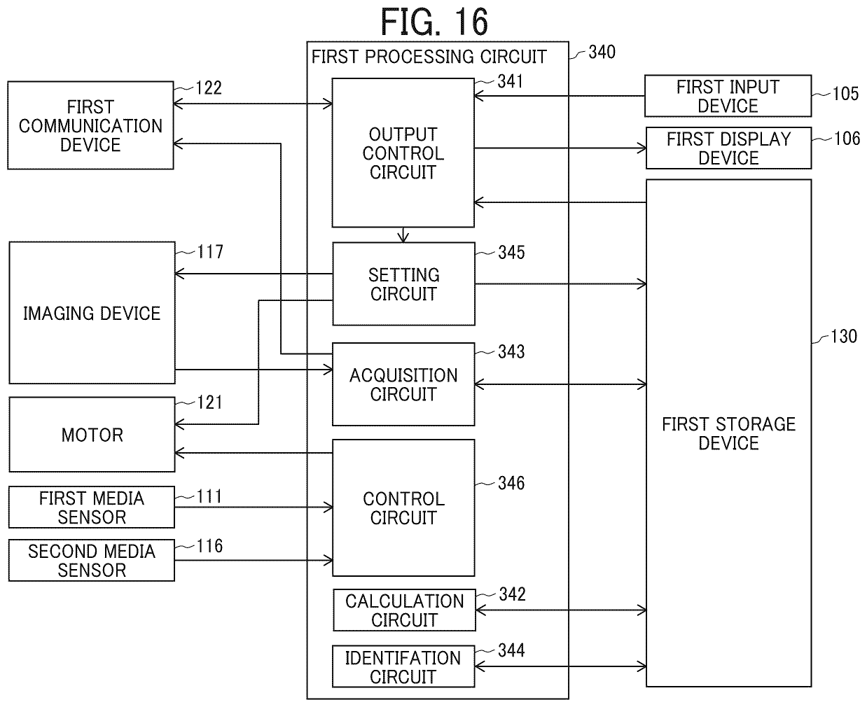

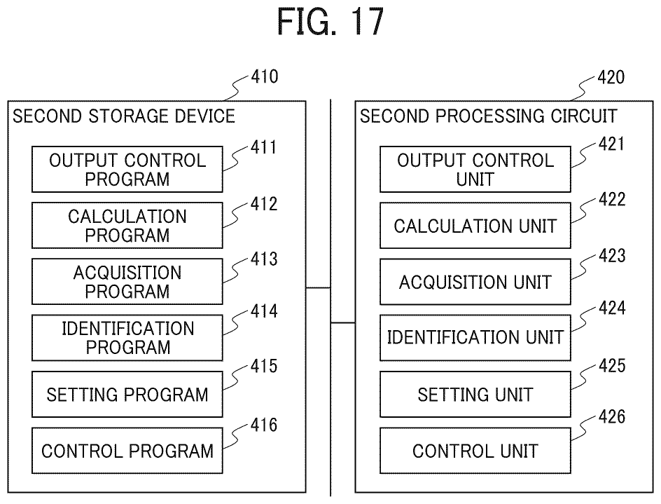

FIG. 16 is a schematic block diagram illustrating a configuration of a first processing circuit 340 in an image reading apparatus according to another embodiment.

The first processing circuit 340 is used instead of the first processing circuit 140 and performs the setting operation and the image reading operation. The first processing circuit 340 includes an output control circuit 341, a calculation circuit 342, an acquisition circuit 343, an identification circuit 344, a setting circuit 345, and a control circuit 346.

The output control circuit 341 is an example of an output control unit and functions in the same or substantially the same manner as the output control unit 141. The output control circuit 341 receives instruction signals from the first input device 105 or the first communication device 122 and reads the degree of matching from the first storage device 130. The output control circuit 341 identifies an important item according to the received instruction signals and the read degree of matching, generates display data items, and outputs the display data items to the first display device 106 or the first communication device 122. Further, the output control circuit 341 outputs a received setting instruction signal to the setting circuit 345.

The calculation circuit 342 is an example of a calculation unit and functions in the same or substantially the same manner as the calculation unit 142. The calculation circuit 342 reads the characteristic information from the first storage device 130, calculates the degree of matching based on the read characteristic information, and stores the degree of matching in the first storage device 130.

The acquisition circuit 343 is an example of an acquisition unit and functions in the same or substantially the same manner as the acquisition unit 143. The acquisition circuit 343 acquires an input image from the imaging device 117 and stores the acquired input image in the first storage device 130. The acquisition circuit 343 reads an input image on which image processing has been performed from the first storage device 130 and outputs the input image to the first communication device 122.

The identification circuit 344 is an example of an identification unit and functions in the same or substantially the same manner as the identification unit 144. The identification circuit 344 reads an input image from the first storage device 130, performs image processing, identifies characteristic information, and stores the input image on which the image processing has been performed and the identified characteristic information in the first storage device 130.

The setting circuit 345 is an example of a setting unit and functions in the same or substantially the same manner as the setting unit 145. The setting circuit 345 receives the setting instruction signal from the output control circuit 341, stores the profile included in the received setting instruction signal in the first storage device 130, and configures the settings of the imaging device 117 or the motor 121.

The control circuit 346 is an example of a control unit and functions in the same or substantially the same manner as the control unit 146. The control circuit 346 receives the first media signal from the first media sensor 111 and the second media signal from the second media sensor 116. The control circuit 346 controls the motor 121 based on the received signals.

As described above in detail, the image reading apparatus using the first processing circuit 340 also can enhance user convenience.

FIG. 17 is a schematic block diagram illustrating a schematic configuration of a second storage device 410 and a second processing circuit 420 of an information processing apparatus according to still another embodiment.

As illustrated in FIG. 17, the second storage device 410 stores an output control program 411, a calculation program 412, an acquisition program 413, an identification program 414, a setting program 415, and a control program 416. These programs are functional modules implemented by software operating on a processor. The second processing circuit 420 reads the programs stored in the second storage device 410 and operates according to the read programs, thereby functioning as an output control unit 421, a calculation unit 422, an acquisition unit 423, an identification unit 424, a setting unit 425, and a control unit 426.

The output control unit 421, the calculation unit 422, the acquisition unit 423, the identification unit 424, the setting unit 425, and the control unit 426 have the same or substantially the same functions as the output control unit 141, the calculation unit 142, the acquisition unit 143, the identification unit 144, the setting unit 145, and the control unit 146 of the image reading apparatus 100, respectively. The second storage device 410 stores the data stored by the first storage device 130. The processes of steps S101 to S115 of the setting operation, and the processes of steps S201 to S209, S211 to S214, and S216 to S218 of the image reading operation are performed by the output control unit 421, the calculation unit 422, the acquisition unit 423, the identification unit 424, the setting unit 425, and the control unit 426.

In steps S101, S105, S107, and S114 of the setting operation, the output control unit 421 outputs display data items or information pieces by displaying the display data items or the information pieces on the second display device 202.

In steps S102, S106, S108, S110, and S115, in response to a user's operations using the second input device 201, the output control unit 421 receives instructions by receiving instruction signals from the second input device 201.

In step S111, the setting unit 425 stores a profile designated by a user in the second storage device 210.

In steps S201 and S205 of the image reading operation, the output control unit 421 outputs display data items or information pieces by displaying the display data items or the information pieces on the second display device 202.

In steps S202, S206, S208, and S218, in response to a user's operations using the second input device 201, the output control unit 421 receives instructions by receiving instruction signals from the second input device 201.

In step S208, the control unit 426 transmits a reading instruction signal to the image reading apparatus 100 via the second communication device 203.

In step S209, the setting unit 425 acquires a profile included in the reading instruction signal. The setting unit 425 stores (sets) the acquired profile in the first storage device 130 and transmits a request signal that requests to generate an input image according to the acquired profile to the image reading apparatus 100 via the second communication device 203. The setting unit 145 of the image reading apparatus 100 receives the request signal from the information processing apparatus 200 via the first communication device 122. The setting unit 145 stores (sets) the profile designated by the received request signal in the first storage device 130 and sets the imaging device 117 and the motor 121 to generate an input image corresponding to the profile. Thus, the setting unit 425 sets the profile designated by the user.

In step S211, the control unit 426 transmits a request signal that requests to drive the motor 121 to the image reading apparatus 100 via the second communication device 203. The control unit 146 of the image reading apparatus 100 receives the request signal from the information processing apparatus 200 via the first communication device 122 and drives the motor 121 according to the received request signal. Thus, the control unit 426 feeds and conveys a medium.

In step S212, the acquisition unit 143 transmits the input image to the information processing apparatus 200 via the first communication device 122. The acquisition unit 423 acquires the input image by receiving the input image from the image reading apparatus 100 via the second communication device 203 and stores the acquired input image in the second storage device 210.

In step S213, the identification unit 424 identifies multiple pieces of characteristic information in input images and stores the identified pieces of characteristic information in the history table in the second storage device 210.

In step S214, the acquisition unit 423 outputs the input image on which image processing has been performed by displaying the input image on the second display device 202.

In step S216, the control unit 426 transmits a request signal that requests to stop the motor 121 to the image reading apparatus 100 via the second communication device 203. The control unit 146 of the image reading apparatus 100 receives the request signal from the information processing apparatus 200 via the first communication device 122 and stops the motor 121 according to the received request signal.

Some of the processes performed by the units of the information processing apparatus described above may be performed by the corresponding units of the image reading apparatus or the corresponding units of another information processing apparatus. With such a configuration, the image processing system can identify an important item more efficiently. Further, the information processing apparatus may acquire an input image and/or characteristic information from multiple image reading apparatuses and identify an important item. With such a configuration, the information processing apparatus can identify an important item with higher accuracy.

As described above in detail, the image processing system can enhance user convenience also when the information processing apparatus performs some of the image reading processes.

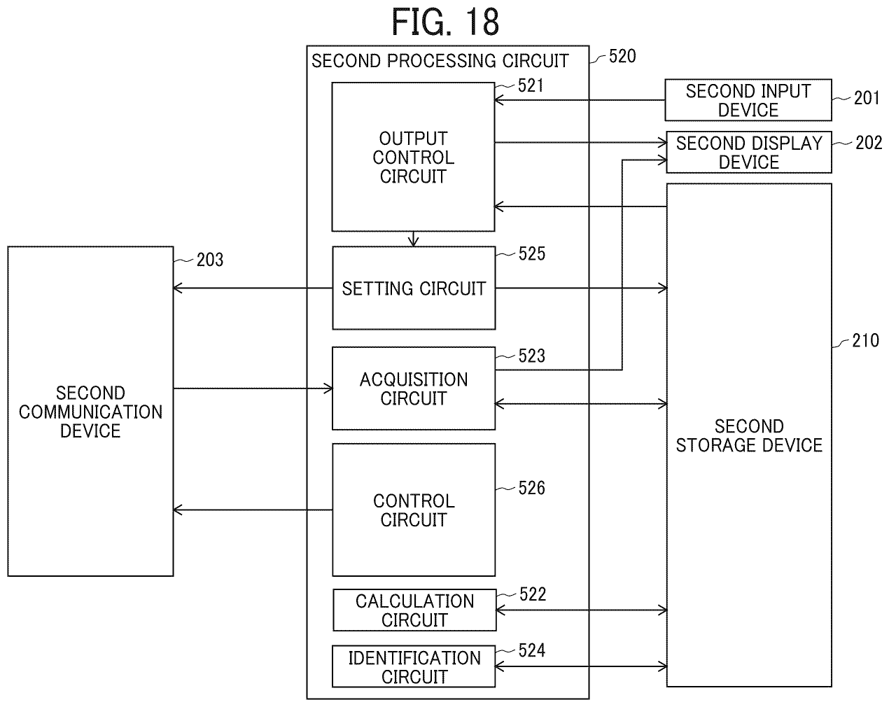

FIG. 18 is a schematic block diagram illustrating a configuration of a second processing circuit 520 in an information processing apparatus according to still another embodiment.

The second processing circuit 520 is used instead of the second processing circuit 420 and performs the image reading operation. The second processing circuit 520 includes an output control circuit 521, a calculation circuit 522, an acquisition circuit 523, an identification circuit 524, a setting circuit 525, and a control circuit 526.

The output control circuit 521 is an example of an output control unit and functions in the same or substantially the same manner as the output control unit 421. The output control circuit 521 receives instruction signals from the second input device 201 and reads the degree of matching from the second storage device 210. The output control circuit 521 identifies an important item according to the received instruction signals and the read degree of matching, generates display data items, and outputs the display data items to the second display device 202. Further, the output control circuit 521 outputs a received setting instruction signal to the setting circuit 525.

The calculation circuit 522 is an example of a calculation unit and functions in the same or substantially the same manner as the calculation unit 422. The calculation circuit 522 reads the characteristic information from the second storage device 210, calculates the degree of matching based on the read characteristic information, and stores the degree of matching in the second storage device 210.

The acquisition circuit 523 is an example of the acquisition unit and functions in the same or substantially the same manner as the acquisition unit 423. The acquisition circuit 523 receives an input image from the second communication device 203 and stores the input image in the second storage device 210. The acquisition circuit 523 reads an input image on which image processing has been performed from the second storage device 210 and outputs the input image to the second display device 202.

The identification circuit 524 is an example of an identification unit and functions in the same or substantially the same manner as the identification unit 424. The identification circuit 524 reads an input image from the second storage device 210, performs image processing, identifies characteristic information, and stores the input image on which the image processing has been performed and the identified characteristic information in the second storage device 210.

The setting circuit 525 is an example of a setting unit and functions in the same or substantially the same manner as the setting unit 425. The setting circuit 525 receives the setting instruction signal from the output control circuit 521, stores the profile included in the received setting instruction signal in the second storage device 210, and outputs the profile to the second communication device 203.

The control circuit 526 is an example of a control unit and functions in the same or substantially the same manner as the control unit 426. The control circuit 526 outputs a reading instruction signal and request signals to the second communication device 203.

As described above in detail, the information processing apparatus using the second processing circuit 520 also can enhance user convenience.

Although the preferred embodiments have been described above, the embodiments are not limited thereto. For example, the multiple setting items included in each of the profiles may include one or more setting items other than the above-described setting items. Further, each of the profile may not include any of the setting items described above.

Furthermore, the image reading apparatus may have a so-called U-turn path, feed media placed on a media tray sequentially from the top, and discharge the media to an ejection tray.

Enhancing user convenience is required in an image processing apparatus.

According to one aspect of the present disclosure, an image processing apparatus, an image processing system, an image processing method, and a control program can enhance user convenience.

In one aspect, a control program for controlling a computer includes a plurality of program codes, which, when executed by the computer, causes the computer to perform a method. The method includes storing a profile including a setting value of each of a plurality of setting items relating to imaging processing or image processing in a memory. The method includes acquiring a plurality of input images obtained by imaging media. The method includes identifying a plurality of pieces of characteristic information respectively relating to the plurality of setting items in the input image. The method includes calculating, for each of the setting items, a degree of matching of each of the plurality of pieces of characteristic information with respect to the setting value in the plurality of input images. The method includes outputting information regarding one or more setting items having the degree of matching equal to or higher than a predetermined value or a predetermined number of setting items in descending order of the degree of matching, among the plurality of setting items.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image processing apparatus, comprising:
a memory that stores a profile including a setting value of each of a plurality of setting items relating to imaging processing or image processing; and
circuitry to:
acquire a plurality of input images obtained by imaging media;
identify a plurality of pieces of characteristic information respectively relating to the plurality of setting items in each of the plurality of input images;
calculate, for each of the setting items, a degree of matching of each of the plurality of pieces of characteristic information with respect to the setting value in the plurality of input images; and
output information regarding one or more setting items having the degree of matching equal to or higher than a predetermined value or a predetermined number of setting items in descending order of the degree of matching, among the plurality of setting items.

2. The image processing apparatus of claim 1, wherein the circuitry is configured to output the information regarding the one or more setting items having the degree of matching equal to or higher than the predetermined value or the predetermined number of setting items in descending order of the degree of matching when receiving designation of the profile.

3. The image processing apparatus of claim 1, wherein the circuitry is configured to output the information regarding the one or more setting items having the degree of matching equal to or higher than the predetermined value or the predetermined number of setting items in descending order of the degree of matching before or during execution of reading of a medium by an image reading apparatus.

4. The image processing apparatus of claim 1, wherein when the setting value included in the profile is changed, the circuitry is configured to calculate, as the degree of matching, a degree of matching of each of the plurality of pieces of characteristic information with respect to the changed setting value of the profile including the changed setting value in the plurality of input images generated according to the profile including the setting value before the change.

5. The image processing apparatus of claim 1, wherein the circuitry is configured to calculate the degree of matching using input images generated in a predetermined time period.

6. An image processing system, comprising:
an image reading apparatus including first circuitry; and
an information processing apparatus including second circuitry,
the first circuitry and the second circuitry being configured to operate in cooperation to:
store a profile including a setting value of each of a plurality of setting items relating to imaging processing or image processing in a memory;
acquire a plurality of input images obtained by imaging media;
identify a plurality of pieces of characteristic information respectively relating to the plurality of setting items in the input image;
calculate, for each of the setting items, a degree of matching of each of the plurality of pieces of characteristic information with respect to the setting value in the plurality of input images; and
output information regarding one or more setting items having the degree of matching equal to or higher than a predetermined value or a predetermined number of setting items in descending order of the degree of matching, among the plurality of setting items.

7. An image processing method, comprising:
storing a profile including a setting value of each of a plurality of setting items relating to imaging processing or image processing in a memory;
acquiring a plurality of input images obtained by imaging media;
identifying a plurality of pieces of characteristic information respectively relating to the plurality of setting items in the input image;
calculating, for each of the setting items, a degree of matching of each of the plurality of pieces of characteristic information with respect to the setting value in the plurality of input images; and
outputting information regarding one or more setting items having the degree of matching equal to or higher than a predetermined value or a predetermined number of setting items in descending order of the degree of matching, among the plurality of setting items.
